(19) United States
(12) Patent Application Publication
(10) Pub. No.: US 2025/0103016 A1
(43) Pub. Date: Mar. 27, 2025

(54) OPERATING APPARATUS AND DISPLAY METHOD

(71) Applicant: Murata Machinery, Ltd., Kyoto-shi, Kyoto (JP)

(72) Inventors: Masahiro KAWAKAMI, Kyoto-shi (JP); Hiroshi YAMAMOTO, Kyoto-shi (JP); Nobuhiro MURASE, Inuyama-shi (JP); Kyosuke MAKITA, Inuyama-shi (JP)

(21) Appl. No.: 18/730,896

(22) PCT Filed: Jan. 23, 2023
(86) PCT No.: PCT/JP2023/001857

§ 371 Date: Jul. 22, 2024

(30) Foreign Application Priority Data
Jan. 24, 2022 (JP) 2022-008935

(51) Int. Cl. G05B 15/02

(52) U.S. Cl. CPC G05B 15/02

(57) ABSTRACT

An operating apparatus to operate an industrial machine including a first element on one side in a predetermined arrangement direction and a second element on another side in the predetermined arrangement direction, includes a touch panel display to display an image and perform input on the image displayed, and a panel display controller configured or programmed to cause the touch panel display to display a first panel usable to perform settings regarding the first element, and a second panel usable to perform settings regarding the second element on the another side with respect to the first panel.

### BACKGROUND OF THE INVENTION

### 1. Field of the Invention

The present invention relates to operating apparatuses and display methods.

### 2. Description of the Related Art

An industrial machine may include a plurality of elements in a predetermined arrangement direction. When an operator manually sets or operates each element of such industrial machine, an operating apparatus is used. As such an operating apparatus, an operating apparatus including a display for displaying images and an input interface for setting or inputting operations, has been proposed to display input panels on the display (see Japanese Patent No. 6377167).

### SUMMARY OF THE INVENTION

When an industrial machine includes multiple elements arranged in a predetermined arrangement direction, an operating apparatus such as that in Japanese Patent No. 6377167, which simply displays input panels on a display, makes it difficult to grasp the correspondence between the input items on the panels and the elements that are to be set or operated through inputs. As a result, there is a risk of input errors.

Example embodiments of the present invention provide operating apparatuses and display methods each capable of reducing input errors that may be made by an operator.

An operating apparatus according to an example embodiment of the present invention is an operating apparatus to operate an industrial machine that includes a first element on one side in a predetermined arrangement direction and a second element on another side in the predetermined arrangement direction, the operating apparatus including a touch panel display to display an image and usable to perform input on the image displayed, and a panel display controller configured or programmed to cause the touch panel display to display a first panel usable to perform settings regarding the first element, and a second panel usable to perform settings regarding the second element on the another side with respect to the first panel, in which, when an input to display a new one of the first panel is performed via the touch panel display, the panel display controller is configured or programmed to display the new one of the first panel on the one side with respect to the second panel having been displayed on the touch panel display, and when an input to display a new one of the second panel is performed via the touch panel display, the panel display controller is configured or programmed to display the new one of the second panel on the another side with respect to the first panel having been displayed on the touch panel display.

A display method according to an example embodiment of the present invention is a display method for an operating apparatus to operate an industrial machine that includes a first element on one side in a predetermined arrangement direction and a second element on another side in the predetermined arrangement direction, the operating apparatus including a touch panel display to display an image and perform input on the image displayed, the display method including causing the touch panel display to display a first panel to perform settings regarding the first element, and a second panel to perform settings regarding the second element on the another side with respect to the first panel, when an input to display a new one of the first panel is performed via the touch panel display, displaying the new one of the first panel on the one side with respect to the second panel having been displayed on the touch panel display, and when an input to display a new one of the second panel is performed via the touch panel display, displaying the new one of the second panel on the another side with respect to the first panel having been displayed on the touch panel display.

According to the operating apparatuses and the display methods of example embodiments of the present invention, the first panel and the second panel are displayed on the display in the same order as that in which the first element and the second element in the industrial machine are arranged, and therefore the operator can readily recognize the first panel or the second panel based on the order in which the first element and the second element are arranged. As a result, it is possible to help prevent the operator from performing inputs in incorrect places and reduce input errors.

In the operating apparatuses of example embodiments of the present invention, the panel display controller may be configured or programmed to cause the display to display a plurality of the first panel and display a plurality of the second panel on the another side with respect to any of the plurality of first panel. As a result, even when a plurality of the first panel and a plurality of the second panel are displayed on the display, the plurality of the second panel are displayed on the another side with respect to the plurality of the first panel, and therefore the operator can readily recognize locations that require inputs.

In the operating apparatuses of example embodiments of the present invention, when an input to display a new first panel is performed via the touch panel display, the panel display controller may be configured or programmed to display the new first panel on the one side with respect to a second panel having been displayed on the display, and when an input to display a new second panel is performed via the touch panel display, the panel display controller may be configured or programmed to display the new second panel on the another side with respect to the first panel having been displayed on the display. As a result, even when a new first panel or a new second panel is to be displayed on the display, the order in which the first panel and the second panel are arranged is maintained, and therefore the operator can readily recognize locations that require inputs.

In the operating apparatuses of example embodiments of the present invention, when an input to display a new first panel is performed via the touch panel display, the panel display controller may be configured or programmed to display the new first panel on the one side with respect to any one of a plurality of the second panel having been displayed on the display, and when an input to display a new second panel is performed via the touch panel display, the panel display controller may be configured or programmed to display the new second panel on the another side with respect to any one of a plurality of the first panel having been displayed on the display. As a result, even when a new first panel or a new second panel is to be displayed on the display while a plurality of the first panel and the second panel are already displayed, the order in which the first panels and the second panels are arranged is maintained, and therefore the operator can readily recognize locations that require inputs.

In the operating apparatuses of example embodiments of the present invention, the panel display controller may be configured or programmed to display one or both of the first panel and the second panel over an entirety of a setting area preliminarily prescribed on the display. As a result, the first panel and the second panel are displayed large in the setting area, and therefore visibility thereof for the operator can be improved. In such operating apparatuses, when displaying a new first panel or a new second panel in the setting area, the panel display controller may be configured or programmed to shrink one or both of the first panel and the second panel that having been displayed first. As a result, the first panel and the second panel having been displayed first are shrunk, and therefore a plurality of the first panel and the second panel can be displayed with balance in the setting area.

In the operating apparatuses of example embodiments of the present invention, the touch panel display is used, and therefore the operator can easily perform an input by touching or manipulating the touch panel display.

In the operating apparatuses of example embodiments of the present invention, the operating apparatus or the touch panel display may be attachable to the industrial machine in a removable manner. As a result, a user or operator can detach the operating apparatus or the touch panel display from the industrial machine and carry it with them. The industrial machine may be a lathe, and the first element and the second element may both be machining units included in the lathe. As a result, input errors can be reduced when the operator inputs settings regarding the machining units of the lathe. Alternatively, the industrial machine may be a loader device, and the first element and the second element may both be transporters included in the loader device. As a result, input errors can be reduced when the operator inputs settings regarding the transporters of the loader device. Also alternatively, the industrial machine may be an automated warehouse, and the first element and the second element may both be transport carriers included in the automated warehouse. As a result, input errors can be reduced when the operator inputs settings regarding the transport carriers of the automated warehouse.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram showing an example of an operating apparatus according to an example embodiment of the present invention.

FIG. 2 is a diagram showing an example of a lathe and a loader device being industrial machines.

FIG. 3 is a diagram showing an example of an initial state of a setting area.

FIG. 4 is a diagram showing an example in which a first panel is displayed in the setting area.

FIG. 5 is a flowchart showing an example of a display method according to an example embodiment of the present invention.

FIG. 6 is a diagram showing an example in which a first panel and a second panel are displayed.

FIG. 7 is a diagram showing an example in which a plurality of first panels and a plurality of second panels are displayed.

FIG. 8 is a diagram showing an example in which a second panel is displayed in addition to a plurality of first panels.

FIG. 9 is a diagram showing an example in which a first panel is displayed in addition to a plurality of second panels.

FIG. 10 is a diagram showing an example of a state in which the setting area is shrunk.

FIG. 11 is a diagram showing an example of an operation for pinning a panel.

FIG. 12 is a diagram showing an example of an operation for recalling a pinned panel.

FIG. 13 is a diagram showing an example of an operation for closing panels.

FIG. 14 is a diagram showing an example of a panel change operation.

FIGS. 15A to 15C are diagrams showing a relationship between an information area and an operation area, in which, FIG. 15A shows a state in which one element is displayed in the information area, FIG. 15B shows a state in which two elements are displayed in the information area, and FIG. 15C shows a state in which three elements are displayed in the information area.

FIG. 16 is a diagram showing an example of a state in which a numeric keypad panel is displayed on the display.

FIG. 17 is a diagram showing an example of the numeric keypad panel.

FIG. 18 is a diagram showing another example of the numeric keypad panel.

FIG. 19 is a diagram showing another example of a lathe being an industrial machine.

FIG. 20 is a diagram showing an example of an automated warehouse being an industrial machine.

### DETAILED DESCRIPTION OF THE EXAMPLE EMBODIMENTS

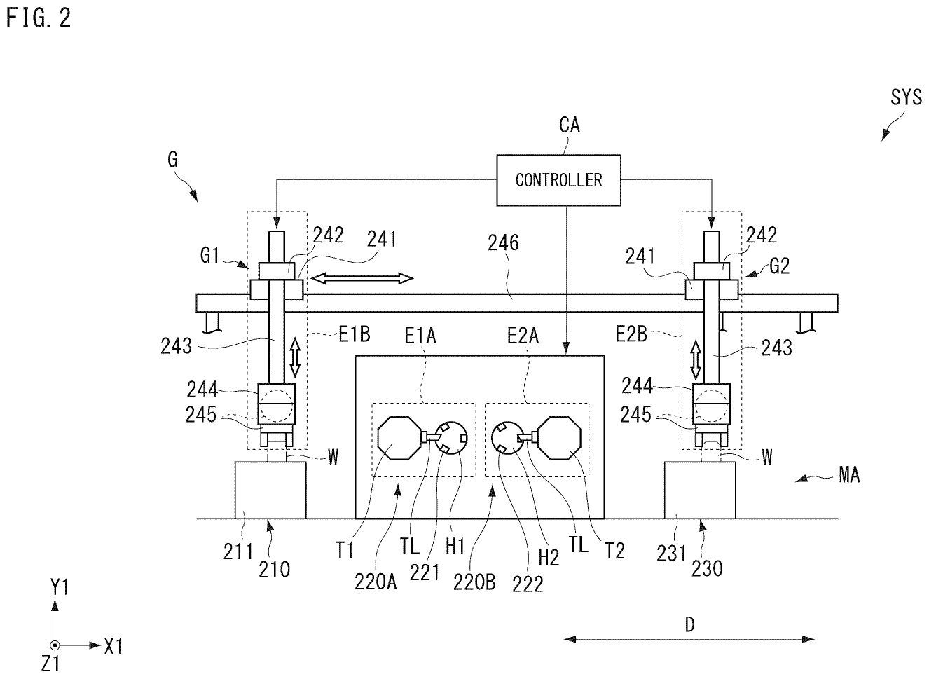

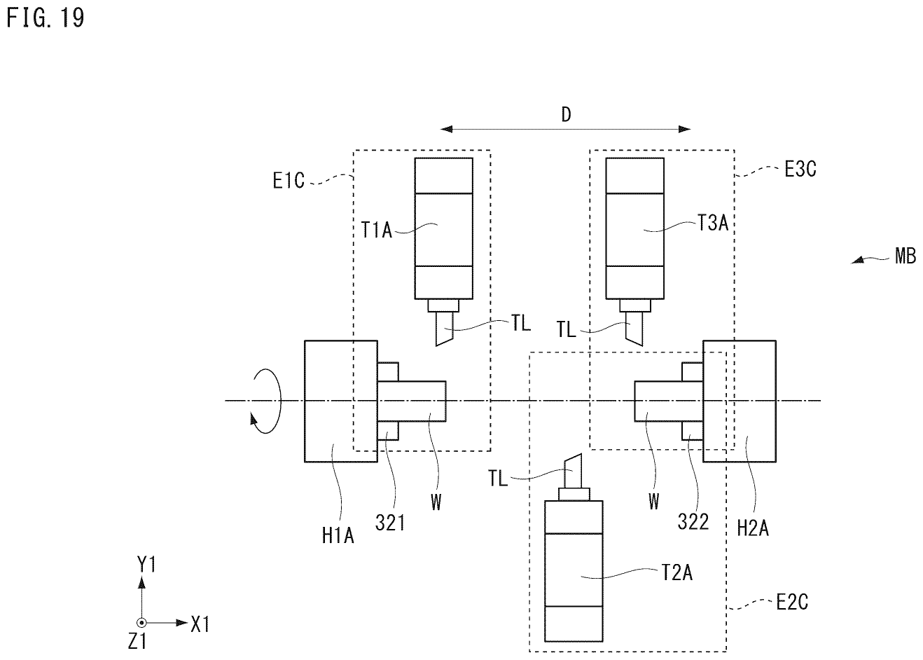

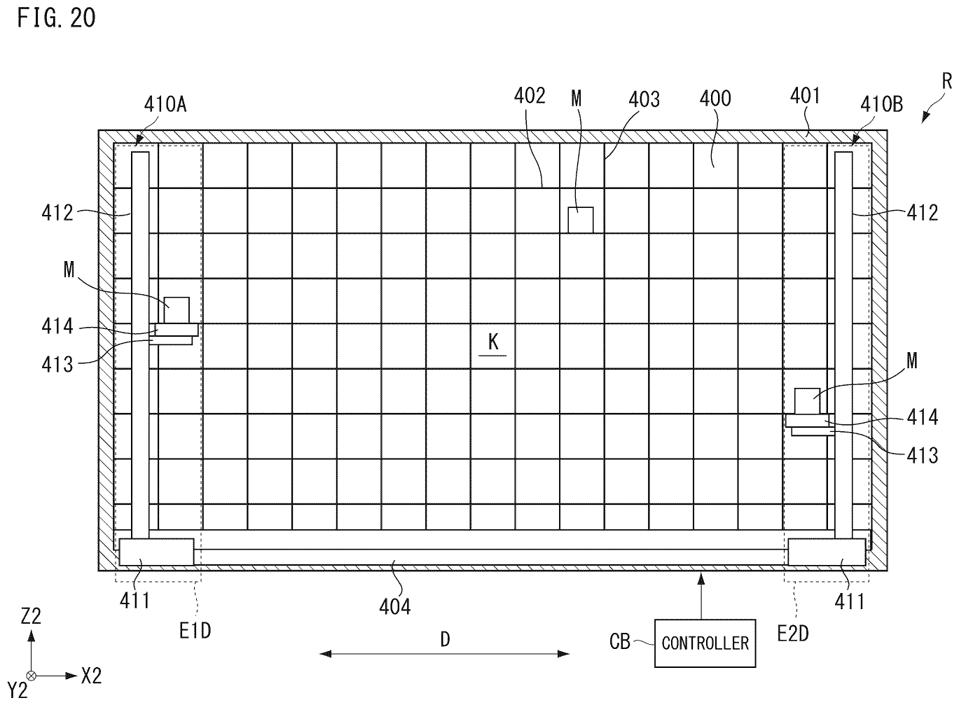

The following describes example embodiments of the present invention, with reference to the drawings. However, the present invention is not limited to the contents described below. In the drawings, scale is changed as necessary to illustrate the example embodiments, such as by enlarging or emphasizing a portion, and the shapes and dimensions in the drawings may differ from those of the actual product. In FIG. 2, FIG. 19, and FIG. 20, an X1Y1Z1 coordinate system or an X2Y2Z2 coordinate system is used to describe directions in the figures. For each of the X1 direction (X2 direction), the Y1 direction (Y2 direction), and the Z1 direction (Z2 direction), description is made with a definition in which a direction indicated by an arrow is the positive (+) direction and a direction opposite to the direction indicated by the arrow is the negative (−) direction.

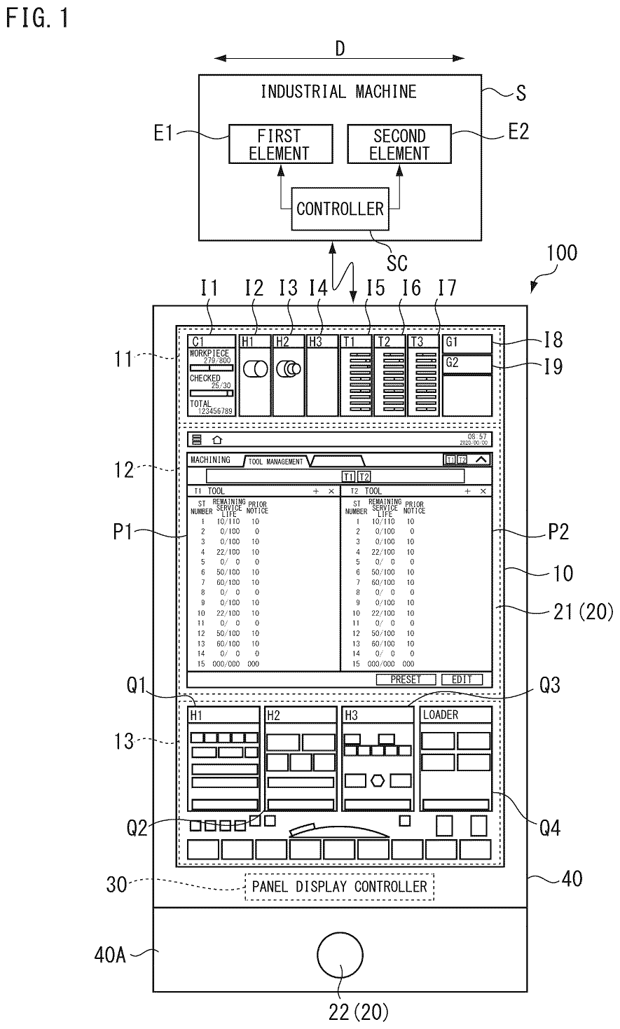

FIG. 1 is a diagram showing an example of an operating apparatus 100 according to the present example embodiment. The operating apparatus 100 is usable by an operator to operate an industrial machine S. The industrial machine S includes a first element E1 on one side in a predetermined arrangement direction D and a second element E2 on another side in the arrangement direction D. The predetermined arrangement direction D may be a horizontal direction (left-right direction) or a vertical direction (up-down direction). In FIG. 1, the left side of the predetermined arrangement direction D is treated as the one side, and the right side as the another side, however, it may be reversed in the example shown in FIG. 1. The details of the first element E1 and the second element E2 of the industrial machine S will be described later. The industrial machine S includes a controller SC configured or programmed to control the first element E1 and the second element E2. The operating apparatus 100 is usable by the operator to operate the first element E1 and the second element E2.

First, an example of the industrial machine S will be described. FIG. 2 is a diagram showing an example of a lathe MA and a loader device G being industrial machines S. In FIG. 2, the lathe MA and the loader device G define a machine tool system SYS. As shown in FIG. 2, the machine tool system SYS includes a controller CA configured or programmed to control the lathe MA and the loader device G. The lathe MA is a parallel twin spindle lathe. The lathe MA includes a loading platform 210, two machining units, namely, first machining unit 220A and second machining unit 220B, and an unloading platform 230. The loading platform 210 has a placement table 211 for placing thereon a workpiece W to be machined. An unmachined workpiece W is placed on the placement table 211. The placement table 211 is configured so as to be able to transfer an unmachined workpiece W to the loader device G.

The first machining unit 220A and the second machining unit 220B each machines a workpiece W using tools TL. The first machining unit 220A has a main spindle H1 and a turret T1. The second machining unit 220A has a main spindle H2 and a turret T2. The main spindles H1, H2 are arranged in line along the X1 direction and are each supported by a bearing or the like not shown in the drawings so as to be able to rotate around an axial line parallel to the Z1 direction. Chucks 221, 222 are provided at +21 side ends of the main spindles H1, H2, respectively. The chucks 221, 222 are opened and closed by a chuck driver not shown in the drawings to grip or release the workpiece W.

The turrets T1, T2 are spaced away from the axial direction of the main spindles H1, H2. The turret T1 is arranged on the −X1 side of the main spindle H1, and the turret 12 is arranged on the −X1 side of the main spindle H2. Each of the turrets 11, 12 can be rotated around an axis parallel to the Z1 direction by a rotation driver not shown in the drawings. A plurality of holders for holding tools TL are provided on the circumferential surfaces of the turrets 11, 12, and tools T are held in all or some of these holders. Thus, the tool TL used for machining a workpiece W is selected by rotating the turrets T1, T2. The tool TL can be replaced for each holder. As the tool TL, not only a tool bit that performs cutting on a workpiece W, but also a rotating tool such as a drill or an end mill may be used. The turrets T1, T2 can be moved in the X1 direction and the Z1 direction by drivers not shown in the drawings.

In the lathe MA, the first machining unit 220A including the main spindle H1 and the turret I1 constitutes a first element E1A, and the second machining unit 220B including the main spindle H2 and the turret 12 constitutes a second element E2A. The first element E1A and the second element E2A are arranged in line along the predetermined arrangement direction D. The first element E1A is arranged on the one side in the arrangement direction D, and the second element E2A is arranged on the another side (right side) in the arrangement direction D. As will be described later, the operating apparatus 100 displays a first panel P1 and a second panel P2 in a setting area 12 of a display 10 in the same order as that in which the first machining unit 220A and the second machining unit 220B are arranged in the arrangement direction D, and therefore the operator can readily grasp the setting target, and input errors and other operational errors can be reduced.

A workpiece W that has been machined by the first machining unit 220A or the second machining unit 220B is placed on the unloading platform 230. The unloading platform 230 has a placement table 231 on which the machined workpiece W is held. The machined workpiece W is held on the placement table 231. The placement table 231 is configured so as to be able to receive the workpiece W from the loader device G.

The loader device G has a first transporter G1 and a second transporter G2. The first transporter G1 and the second transporter G2 have similar configurations. The first transporter G1 is arranged on the one side (left side) in the arrangement direction D, and the second transporter G2 is arranged on the another side (right side) in the arrangement direction D, and both the first transporter G1 and the second transporter G2 can transport a workpiece W between the loading platform 210, the first machining unit 220A, the second machining unit 220B, and the unloading platform 230. The first transporter G1 and the second transporter G2 each include an X-slider 241, a Z-slider 242, an elevation rod 243, a loader head 244, and two loader chucks 245. The X-slider 241 can be moved in the X1 direction along a rail 246 extending in the X1 direction by means of an X-driver not shown in the drawings.

The Z-slider 242 can be moved in the Z1 direction along a Z guide not shown in the drawings but included in the X-slider 241 by means of a Z-driver not shown in the drawings. The elevation rod 243 can be raised or lowered (can be moved in the Y1 direction) along an elevation guide not shown in the drawings but included in the Z-slider 242, via an elevation driver not shown in the drawings. The loader head 244 is provided at a lower end of the elevation rod 243 and is raised or lowered integrally with the elevation rod 243. The two loader chucks 245 are provided on the loader head 244 and can each grip a workpiece W. The two loader chucks 245 can move to a posture where the workpiece W is gripped and oriented in the −Z1 direction (a posture where the workpiece W is oriented toward the main spindles H1, H2), and a posture where the workpiece W is oriented downward (−Y1 direction), for example, via a swivel joint and the like.

In the loader device G, the first transporter G1 constitutes a first element E1B, and the second transporter G2 constitutes a second element E2B. The first element E1B and the second element E2B are arranged in line along the predetermined arrangement direction D. The first element E1B is arranged on the one side (left side) in the arrangement direction D, and the second element E2B is arranged on the another side (right side) in the arrangement direction D. As will be described later, the operating apparatus 100 displays a first panel P1 and a second panel P2 in the setting area 12 of the display 10 in the same order as that in which the first transporter G1 and the second transporter G2 are arranged in the arrangement direction D, and therefore the operator can readily grasp the setting target, and operational errors such as input errors can be reduced.

As shown in FIG. 1, the operating apparatus 100 includes the display 10, an input interface 20, a panel display controller 30, and a casing 40 that holds or houses these components. The operating apparatus 100 may be removably attached to a portion or structure of the industrial machine S (for example, to a front side thereof) or may be fixed to the industrial machine S. In other words, the operating apparatus 100 may be a so-called tablet terminal equipped with a touch panel display or may be installed in the industrial machine S (provided as a part of the industrial machine S). The operating apparatus 100 includes a communicator not shown in the drawings and can be connected in a wired or wireless manner to the controller SC of the industrial machine S. The operating apparatus 100 may be capable of communicating with a host controller or the like of the industrial machine S.

By providing inputs to the operating apparatus 100, the operator can change the settings for the first element E1 and the second element E2 or operate (instruct the operation of) the first element E1 and the second element E2 via the controller SC of the industrial machine S. In the present example embodiment, the operating apparatus 100 for the machine tool system SYS (see FIG. 2) having the lathe MA and the loader device G as an industrial machine S will be described.

The display 10 displays images. For example, an information area 11, a setting area 12, and an operation area 13 are preliminarily set on the display 10. The information area 11 is arranged in an upper region of the display 10 in the vertical direction (up-down direction). The setting area 12 is arranged in an intermediate region of the display 10 in the vertical direction. The operation area 13 is arranged in a lower region of the display 10 in the vertical direction. It should be noted that the arrangement of the information area 11, the setting area 12, and the operation area 13 on the display 10 is arbitrary and is not limited to the illustrated example. For example, the information area 11 may be arranged in an intermediate region of the display 10 in the vertical direction.

The information area 11 displays information regarding each element of the industrial machine S. In the information area 11, information for the operator to constantly check each element is displayed in a panel (window). In the example shown in FIG. 1, the information area 11 displays a panel I1 concerning a counter, panels 12, 13, 14 concerning main spindles H1, H2, H3, panels 15, 16, 17 concerning a plurality of tools TL mounted on turrets T1, T2, T3, and panels 18, 19 concerning a loader device G. The panel I1 displays, for example, the number of workpieces W machined in one lot, the number of machined workpieces W checked in a preliminarily set number of inspections, the total number of machined workpieces W, and so forth, on the basis of a production plan “C1” performed by the machine tool system SYS (see FIG. 2). The contents and the arrangement thereof to be displayed on the panel I1 can be set arbitrarily.

The panels 12, 13 are displayed side by side in the information area 11 in the same arrangement direction D as that in which the first element E1 and the second element E2 of the industrial machine S (such as the lathe MA) are arranged. The panels 15, 16 are also displayed side by side in the information area 11 in the same arrangement direction D as that in which the first element E1 and the second element E2 of the industrial machine S are arranged. By displaying the information area 11 in such a manner, the order in which the first element E1 and the second element E2 are arranged is the same as the order of display in the information area 11, and therefore the operator can readily recognize the correspondence between the first element E1 and the second element E2, and the panels I2, I3, I4 or the panels I5, I6, I7.

The panel 12 displays information regarding the main spindle H1 included in the first machining unit 220A serving as the first element E1 of the lathe MA, which is an example of the industrial machine S, and the panel I3 displays information regarding the main spindle H2 included in the second machining unit 220B serving as the second element E2 of the lathe MA. The panel I4 is displayed when a corresponding element (main spindle H3) is present in the industrial machine S. The panel I5 displays information concerning the tool TL on the turret I1 included in the first machining unit 220A, and the panel I6 displays information concerning the tool TL on the turret T2 included in the second machining unit 220B. The panel I7 is displayed when a corresponding element (turret T3) is present in the industrial machine S. The panels I5, I6, I7 display information such as the total number of machining operations and the total machining time for each of the multiple tools TL held by the turrets T1, T2.

The panel I8 displays information concerning the first transporter G1 serving as the first element E1 in the loader device G, which is another example of the industrial machine S. The panel I9 displays information concerning the second transporter G2 serving as the second element E2 in the loader device G. The panels I8, I9 are vertically arranged in the upper region within the information area 11, however, are not limited to this configuration and may be arranged side by side. In such a case, the panels I8, I9 are displayed side by side in the information area 11 in the same arrangement direction D as that in which the first element E1 and the second element E2 of the loader device G are arranged. The display contents of the panels I8, I9 are arbitrary. In the information area 11, below the panels I8, I9, a diagram schematically showing the operating status of the loader device G may be displayed.

In the setting area 12, a screen is displayed for the operator to perform settings for each element of the industrial machine S. In the setting area 12, a first panel P1 and a second panel P2 (hereinafter, simply referred to as panels P when no particular distinction is made) are displayed. The first panel P1 and the second panel P2 are displayed side by side in the information area 12 in the same arrangement direction D as that in which the first element E1 and the second element E2 of the industrial machine S are arranged. In other words, just as the second element E2 is provided on the another side with respect to the first element E1 in the arrangement direction D in the industrial machine S, the second panel P2 is displayed on the another side with respect to the first panel P1 in the arrangement direction D. The first panel P1 displays, for example, information for performing settings related to the tool TL in the turret T1, which is the first element E1. The second panel P2 displays, for example, information for performing settings related to the tool TL in the turret T2, which is the second element E2. The first panel P1 and the second panel P2 in the setting area 12 will be described in detail later.

In the operation area 13, the panels Q are displayed for the operator to operate the respective elements of the industrial machine S. These panels Q receive inputs from the operator to enable the operator to directly operate (manually operate) the elements of the industrial machine S, for example. In the example shown in FIG. 1, in the operation area 13, panels Q1, Q2, Q3 for operating the main spindles H1, H2, H3, and a panel Q4 for operating the loader device G are displayed. The panels Q1, Q2, Q3 are displayed side by side in the operation area 13 in alignment with the arrangement direction D of the spindles H1, H2, H3, corresponding respectively to the first element E1, the second element E2, and the third element E3, in the same order. By displaying the operation area 13 in this manner, the operator can readily recognize the correspondence between the first element E1, the second element E2, the third element E3 and the panels Q1, Q2, Q3, thereby reducing operational errors such as input errors made by the operator.

The panel Q1 displays information usable to operate the main spindle H1 corresponding to the first element E1 or the turret T1 corresponding to the main spindle H1. The panel Q2 displays information usable to operate the main spindle H2 corresponding to the second element E2 or the turret 12 corresponding to the main spindle H2. The panel Q3 is displayed when the industrial machine S has a corresponding element (for example, the main spindle H3 or the turret 13 corresponding to the main spindle H3). The display contents in the panels Q1, Q2, Q3 are set according to the operation of each element, and information necessary for the operation of each element is displayed. The panel Q4 displays information usable to operate the loader device G. The panel Q4 is usable by switching display between the first transporter G1 serving as the first element E1 and the second transporter G2 serving as the second element E2 included in the loader device G, however, example embodiments of the present invention are not limited to this use mode, and two panels corresponding to the first element E1 and the second element E2 may be displayed side by side. In such a case, the two panels may be displayed side by side in the operation area 13 in the same arrangement direction D as that in which the first element E1 and the second element E2 of the loader device G are arranged.

The input interface 20 accepts an input performed on the image displayed on the display 10. In the present example embodiment, a touch pad 21 provided in a region overlapping the display 10 is used as the input interface 20. In other words, the display 10 and the touch pad 21 define a touch panel display. Using the touch pad 21 (touch panel display), the operator can easily provide inputs by touching the display portion.

A rotary switch 22 included in the input interface 20 is provided in a lower part 40A of the casing 40. The rotary switch 22 is rotated by the operator to input settings or operations of each element. The rotary switch 22 is mainly used when performing an input operation on the panel Q displayed in the operation area 13. Various buttons such as an emergency stop button may also be provided in the lower portion 40A of the casing 40. It should be noted that the input interface 20 is not limited to being a touch pad 21 (touch panel). For example, a mouse, a keyboard, a jog dial, or the like may be connected to the operating apparatus 100 and used as the input interface 20.

The panel display controller 30 is configured or programmed to control display on the display 10. The panel display controller 30 is mounted in or on the casing 40. The panel display controller 30 is configured or programmed to control the arrangement of the panels corresponding to the information area 11, the setting area 12, and the operation area 13, and the contents to be displayed on the panels. The panel display controller 30 may include a memory storage to store information related to the information area 11, the setting area 12, and the operation area 13. The panel display controller 30 accepts a content input via the touch pad 21 (input interface 20), reads out information corresponding to the received content from the storage unit, and displays it on the display 10. For example, when information on the first element E1 is selected, the panel display controller 30 displays the first panel P1 for performing settings concerning the first element E1 in the setting area 12 on the display 10. For example, when information on the second element E2 is selected, the panel display controller 30 displays the second panel P2 for performing settings concerning the second element E2 in the setting area 12 on the display 10.

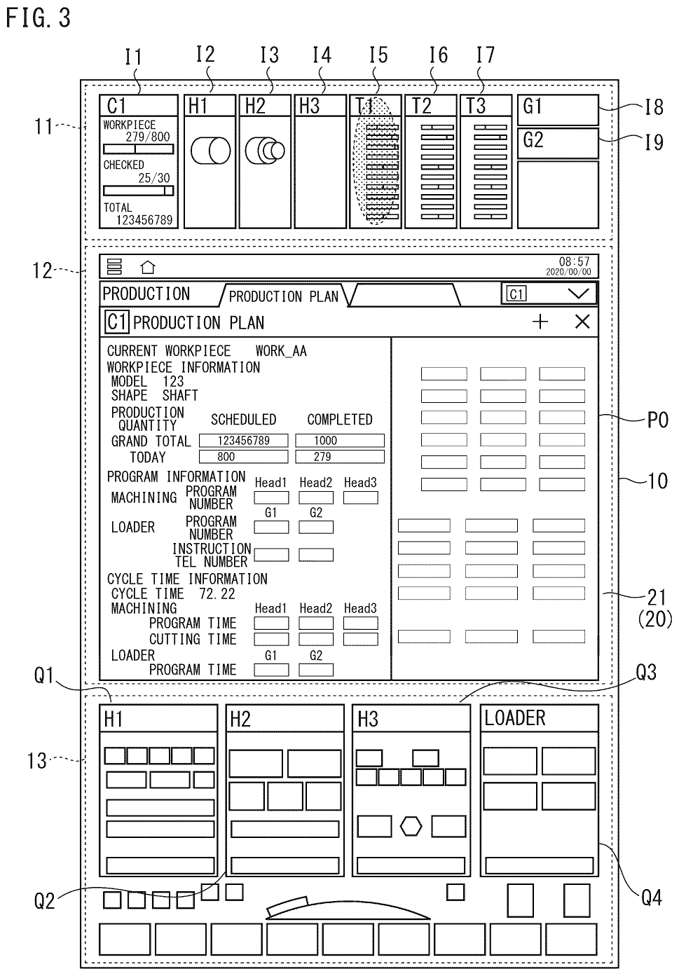

FIG. 3 is a diagram showing an example of the initial state of the setting area 12. As shown in FIG. 3, the setting area 12 displays a panel P0 concerning the production plan “C1”. In this state, when the operator performs a touch input operation on one of the panels I1 to I9 for the elements displayed in the information area 11, the panel display controller 30 displays the panel corresponding to the panels I1 to I9 for the elements selected by the touch input operation in the setting area 12. In FIG. 3, an elliptical figure surrounded by a dashed line is superimposed on the panel 15 for the turret T1 displayed in the information area 11, indicating that the panel I5 has been touch-inputted by the operator.

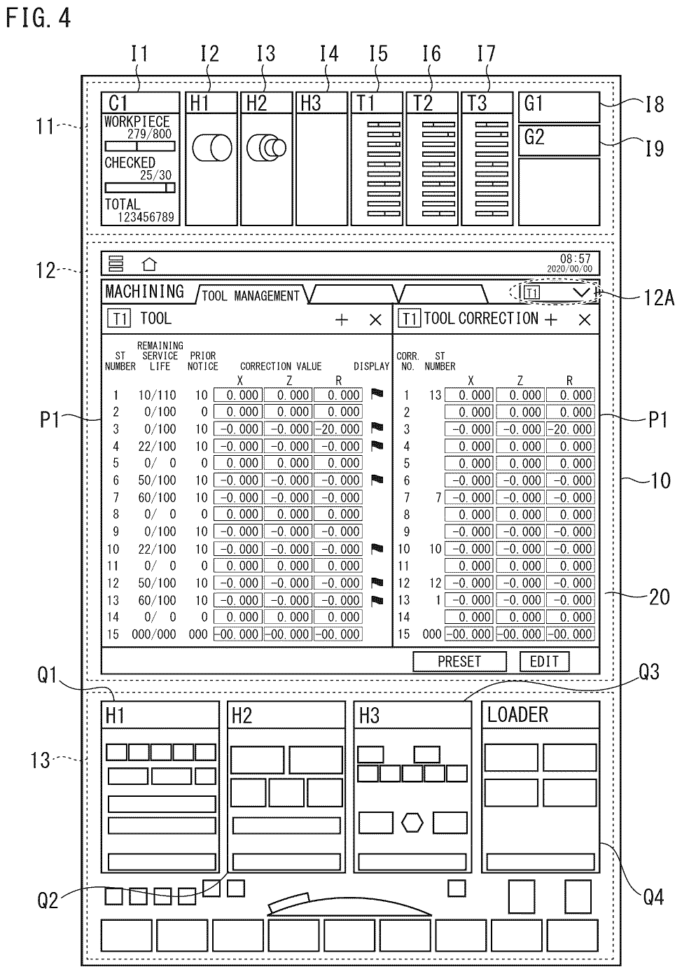

FIG. 4 is a diagram showing an example in which a first panel P1 is displayed in the setting area 12. In the state shown in FIG. 3, when a touch input is performed on the panel 15 in the information area 11, the panel display controller 30 displays the first panel P1 for performing settings related to the first element E1, that is, the turret T1, in the setting area 12 of the display 10, as shown in FIG. 4. In such a case, the panel display controller 30 can display a plurality of first panels P1 in the setting area 12. In FIG. 4, for example, a first panel P1 for performing settings related to the service life of the tool TL in the turret I1 and a first panel P1 for performing settings related to position correction for the tool TL in the turret I1 are displayed side by side in the setting area 12. When a plurality of first panels P1 are to be displayed in the setting area 12, the width of each of the first panels P1 in the left-right direction (arrangement direction D) may be the same or different.

When a touch input is performed on the panel 15 of the information area 11, one first panel P1 may be displayed in the setting area 12. When a touch input is performed on the panels I1 to I9 of the information area 11, the selection of one or more first panels P1 to display is determined in advance by the setting made by the operator or by the initial setting. When a touch input is performed on one of the panels I1 to I9 in the information area 11, the panel display controller 30 displays one or more predetermined first panels P1 in the setting area 12.

In the state shown in FIG. 3, when a touch input is performed on the panel 16 in the information area 11, the panel display controller 30 displays the second panel P2 for performing settings related to the second element E2, that is, the turret T2, in the setting area 12 of the display 10. In such a case, the panel display controller 30 may display a plurality of second panels P2 in the setting area 12 or may display one second panel P2 in the setting area 12. The selection of one or more of the second panels P2 to display is determined in advance by the settings made by the operator or by the initial settings, as with the first panel P1 mentioned above. When a plurality of second panels P2 are to be displayed in the setting area 12, the width of each of the second panels P2 in the left-right direction (arrangement direction D) may be the same or different.

Each of the first panel P1 and the second panel P2 may include a plurality of tabs when displayed. In the state where the first panel P1 or the second panel P2 is displayed in the setting area 12, when the operator performs a touch input on the tab of either one of the panels, the panel display controller 30 switches the display contents within the panel. In such a case, the panel display controller 30 switches the display within the panel so that when a touch input is performed on the tab of the first panel P1, the content related to the first panel P1 (that is, information related to the first element E1) is displayed, and when a touch input is performed on the tab of the second panel P2, the content related to the second panel P2 (that is, information related to the second element E2) is displayed.

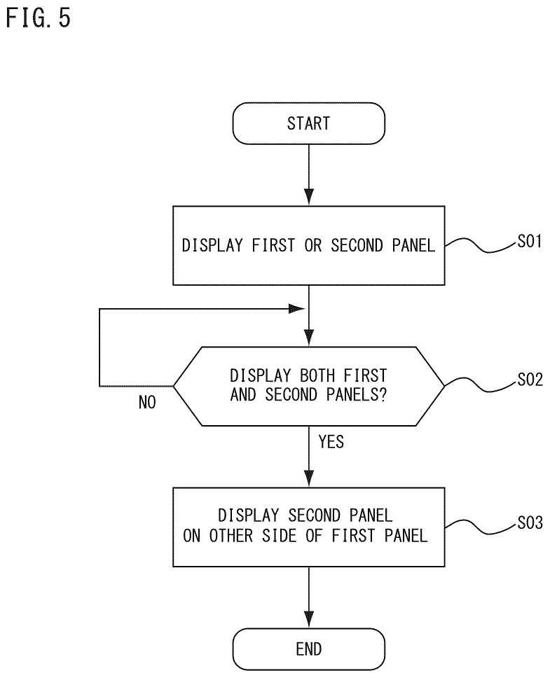

FIG. 5 is a flowchart showing an example of a display method according to an example embodiment of the present invention. FIG. 5 illustrates cases where both a first panel P1 and a second panel P2 are simultaneously displayed in the setting area 12 of the display 10. This includes a case of displaying the first panel P1 followed by the second panel P2, or a case of displaying the second panel P2 followed by the first panel P1. When the first panel P1 and the second panel P2 are displayed simultaneously on the display 10, the panel display controller 30 displays the second panel P2 on the another side with respect to the first panel P1 in the arrangement direction D in the setting area 12 of the display 10. In other words, the panel display controller 30 controls the display of the first panel P1 and the second panel P2 in the setting area 12 on the display 10 so that the arrangement order of the first panel P1 and the second panel P2 in the arrangement direction D matches the arrangement order of the first element E1 and the second element E2 of the industrial machine S in the arrangement direction D.

As shown in FIG. 5, when the first element E1 is selected by the operator, the panel display controller 30 displays the first panel P1 in the setting area 12 (Step S01). That is to say, when the operator performs a touch input on the panel 15 related to the first element E1 in the information area 11, the panel display controller 30 displays the first panel P1 in the setting area 12. In Step S01, when the second element E2 is selected by the operator, the panel display controller 30 displays the second panel P2 in the setting area 12. That is to say, when the operator performs a touch input on the panel 16 related to the second element E2 in the information area 11, the panel display controller 30 displays the second panel P2 in the setting area 12.

Next, after having displayed the first panel P1 or the second panel P2, the panel display controller 30 determines whether or not to simultaneously display both the first panel P1 and the second panel P2 in the setting area 12 (Step S02). For example, in the state shown in FIG. 4, the panel display controller 30 determines whether or not a touch input has been performed on a button 12A displayed in the setting area 12. A series of operations performed by the operator, including the touch input on the button 12A, correspond to an input performed through the input interface 20 to display a new first panel P1 or a new second panel P2. The panel display controller 30 may display a ribbon in the setting area 12 to select either the turret I1 or the turret 12 in response to a touch input performed on the button 12A. In such a case, for example, the panel display controller 30 may display the second panel P2 in the setting area 12 when the operator selects the turret 12 in the ribbon by performing a touch input in the state shown in FIG. 4.

If it is determined that a touch input is made on the button 12A while the first panel P1 has been displayed in the setting area 12, and that an operation is performed to display the second panel P2 in the setting area 12 in addition to the first panel P1, the panel display controller 30 determines that both the first panel P1 and the second panel P2 are to be displayed simultaneously in the setting area 12. If it is determined that a touch input is made on the button 12A while the second panel P2 has been displayed in the setting area 12, and that an operation is performed to display the first panel P1 in the setting area 12 in addition to the second panel P2, the panel display controller 30 determines that both the first panel P1 and the second panel P2 are to be displayed simultaneously in the setting area 12.

If it is determined that an operation has been performed to display the second panel P2 in the setting area 12 in addition to the first panel P1 while this first panel P1 has been displayed in the setting area 12 (YES in Step S02), the panel display controller 30 displays the second panel P2 on the another side (right side) with respect to the first panel P1 in the arrangement direction D in the setting area 12 (Step S03).

If it is determined that an operation has been performed to display the first panel P1 in the setting area 12 in addition to the second panel P2 while this second panel P2 has been displayed in the setting area 12 (YES in Step S02), the panel display controller 30 displays the first panel P1 on the one side (right side) with respect to the second panel P2 in the arrangement direction D in the setting area 12 (Step S03).

In the state where one of the first panel P1 and the second panel P2 has been displayed in the setting area 12, if the other of the first panel P1 and the second panel P2 is not to be displayed (that is to say, if no touch input is made on the button 12A), the panel display controller 30 determines not to display both the first panel P1 and the second panel P2 simultaneously in the setting area 12 (NO in Step S02) and repeats the processing of Step S02.

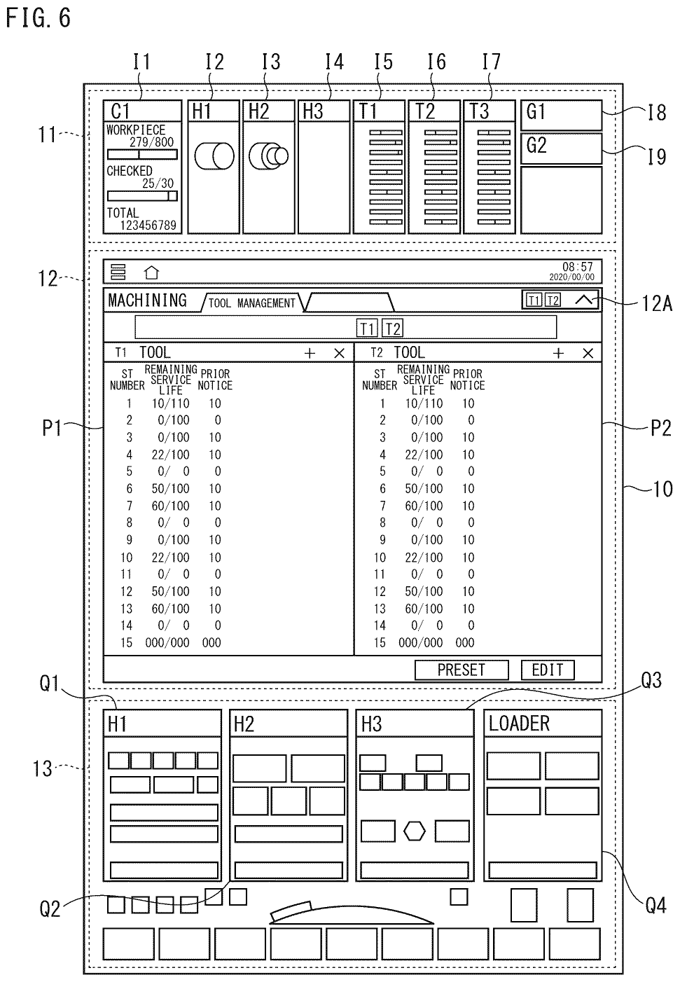

FIG. 6 is a diagram showing an example in which a first panel P1 and a second panel P2 are displayed. FIG. 6 shows an example in which one first panel P1 and one second panel P2 are displayed simultaneously in the setting area 12. If the operator performs a touch input on the button 12A while one first panel P1 (or second panel P2) is already displayed in the setting area 12, the panel display controller 30 displays the first panel P1 and the second panel P2 simultaneously in the setting area 12. At this time, the panel display controller 30 displays the second panel P2 on the another side with respect to the first panel P1 in the arrangement direction D, as shown in FIG. 6. In other words, the first panel P1 is displayed on the one side with respect to the second panel P2 in the arrangement direction D.

When displaying one first panel P1 (or one second panel P2) in the setting area 12, the panel display controller 30 displays one first panel P1 (or one second panel P2) using the entire setting 12, for example. When simultaneously displaying the second panel P2 (or the first panel P1) from this state, the panel display controller 30 shrinks the first panel P1 (or the second panel P2) having been displayed first in the left-right direction (arrangement direction D) and displays the new second panel P2 (or the first panel P1) in the setting area 12. When shrinking a first panel P1 or a second panel P2, the display within the panel may be shrunk or changed to a simplified display. The widths in the left-right direction of the first panel P1 and the second panel P2 displayed in the setting area 12 may be the same or different.

Here, if an operation to display a new panel P is performed in the state where panels P are already displayed in the setting area 12, the panel display controller 30 is basically configured or programmed to display the new panel P farthest on the another side in the arrangement direction D in the setting area 12. With such a configuration, if the new panel P displayed farthest on the another side in the arrangement direction D in the setting area 12 is a first panel P1 and a second panel P2 is among the panels P already displayed in the setting area 12, the panel display controller 30 is configured or programmed to perform control such that the new panel P (first panel P1) is to be displayed on the one side with respect to this second panel P2. At this time, if the panels P already displayed in the setting area 12 include multiple second panels P2, the panel display controller 30 is configured or programmed to perform control such that the new panel P (first panel P1) is to be displayed on the one side with respect to any of the multiple second panels P2. If the new panel P displayed farthest on the another side in the arrangement direction D in the setting area 12 is a second panel P2, the panel display controller 30 ends the processing regardless of the type of the panels P already displayed in the setting area 12 (maintaining the display state in which the new second panel P2 is displayed farthest on the another side in the arrangement direction D). In other words, in the case where the new panel P is a second panel P2, even if a first panel P1 is among the panels P already displayed in the setting area 12, it is ensured that the second panel P2 is displayed on the another side with respect to the first panel P1, and the panel display controller 30 thus ends the processing.

If an input is performed to display a new first panel P1 in the state where at least a second panel P2 is already displayed in the setting area 12, the panel display controller 30 first displays the new first panel P1 on the another side with respect to the second panel P2 already displayed in the setting area 12, and then, swaps the positions of the new first panel P1 and the second panel P2 to thereby display the new first panel P1 on the one side with respect to the second panel P2 in the arrangement direction D. That is to say, the panel display controller 30 displays the new first panel P1 on the another side in the arrangement direction D of the second panel P2 already displayed in the setting area 12 for a predetermined period of time (for example, an extremely short period of time such as about 0.5 seconds), and then swaps the positions of the new first panel P1 and the second panel P2.

If an input is performed to display a new first panel P1 in the state where a plurality of second panels P2 are already displayed in the setting area 12, the panel display controller 30 first displays the new first panel P1 on the another side in the arrangement direction D of any of the plurality of second panels P2 already displayed in the setting area 12, and then moves the new first panel P1 to the one side with respect to any of the plurality of second panels P2 in the arrangement direction D while moving the plurality of second panels P2 to the another side with respect to the new first panel P1 in the arrangement direction D, to thereby display the new first panel P1 on the one side with respect to any of the plurality of second panels P2 in the arrangement direction D.

Thus, when displaying a new panel P in the setting area 12, the panel display controller 30 first displays it farthest on the another side in the arrangement direction D. The reason for this is that if the new first panel P1 is displayed on the one side with respect to the second panel P2 in the arrangement direction D to begin with, there is a chance that the user will not know whether the new first panel P1 was originally displayed in that position or if it has been newly displayed in that position. Therefore, the panel display controller 30 once displays the new first panel P1 on the another side with respect to the second panel P2 in the arrangement direction D as described above, and then swaps the positions of the first panel P1 and the second panel P2. This enables the user to perceive that the first panel P1 is newly displayed, while aligning the arrangement manner of the panels P with that of the elements of the industrial machine S.

On the other hand, if an input is performed to display a new second panel P2 in the state where one or more first panels P1 are already displayed in the setting area 12, the panel display controller 30 displays the new second panel P2 on the another side with respect to any of the first panels P1 in the arrangement direction D from a time point at which displaying starts. As described above, the panel display controller 30 is basically configured or programmed to display a new panel P farthest on the another side in the arrangement direction D in the setting area 12. Thus, when displaying the new second panel P2, it is acceptable to display this new second panel P2 on the another side with respect to the first panel P1 in the arrangement direction D from a time point at which displaying starts, and this enables the user to perceive that the second panel P2 is newly displayed, while aligning the arrangement manner of the panels P with that of the elements of the industrial machine S.

Moreover, when displaying a new panel P in the setting area 12, the panel display controller 30 may first display the new panel P without designating whether it is a first panel P1 or a second panel P2, and then further accept designation of whether the new panel P is a first panel P1 or a second panel P2. In other words, the panel display controller 30 first displays a new panel P that can be either a first panel P1 or a second panel P2. The new panel P may have an operating button (not shown in the drawings) displayed for accepting designation of whether it is a first panel P1 or a second panel P2, and the user may designate whether it is a first panel P1 or a second panel P2 by performing a touch input on the button, causing the newly displayed panel P to be a first panel P1 or a second panel P2.

In such a case, if an operation to display a new panel P is performed in the state where panels P are already displayed in the setting area 12, the panel display controller 30 basically displays the new panel P farthest on the another side in the arrangement direction D in the setting area 12. In other words, if an input is performed to display a new panel P in the state where one or more second panels P2 are already displayed in the setting area 12, the panel display controller 30 first displays the new panel P on the another side in the arrangement direction D of any of the second panels P2 already displayed in the setting area 12, and then further accepts designation of whether the new panel P is a first panel P1 or a second panel P2. Then, if the new panel P is designated as a first panel P1, the panel display controller 30 swaps the position of the new panel P, which has been designated as a first panel P1, and the position of the second panel P2, to thereby display the new panel P (first panel P1) on the one side with respect to the second panel P2 in the arrangement direction D. On the other hand, in the case where the new panel P is designated as a second panel P2, even if one or more first panels P1 are already displayed on the one side with respect to the new panel P in the arrangement direction D, the panel display controller 30 still maintains the relative positional relationship between the first panels P1 and the new second panel P2 without swapping their positions.

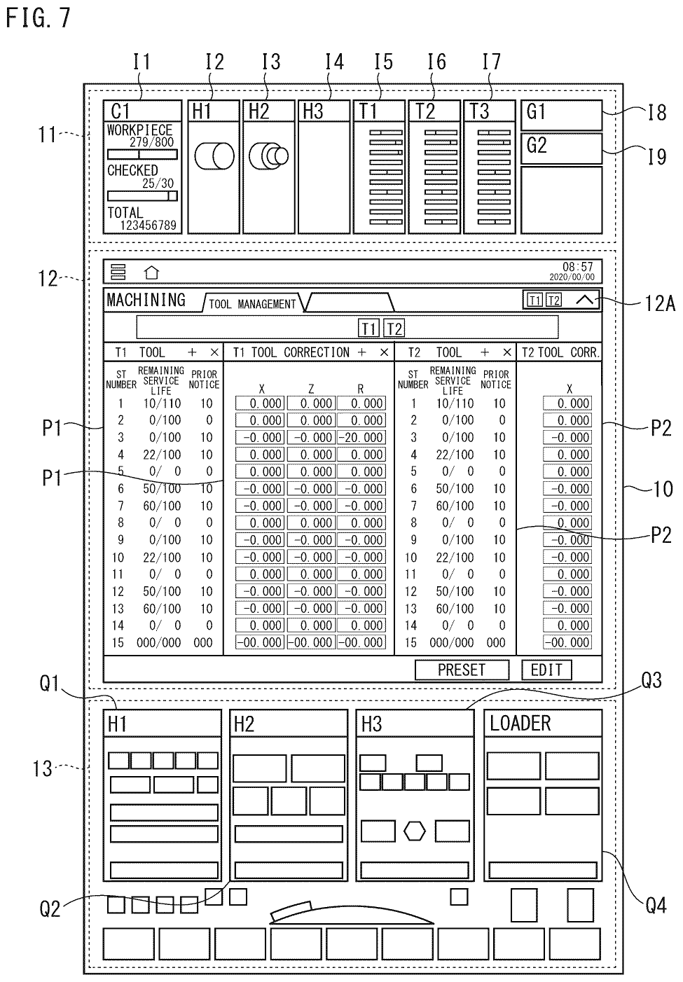

FIG. 7 is a diagram showing an example in which a plurality of first panels P1 and a plurality of second panels P2 are displayed. The panel display controller 30 can display a plurality of (two) first panels P1 and a plurality of (two) second panels P2 in the setting area 12 at the same t Even when displaying a plurality of first panels P1 and a plurality of second panels P2 simultaneously in the setting area 12, the panel display controller 30 displays the plurality of second panels P2 on the another side with respect to the plurality of first panels P1 in the arrangement direction D, as shown in FIG. 7.

Moreover, when displaying a plurality of first panels P1 and a plurality of second panels P2 simultaneously in the setting area 12, in comparison to displaying multiple first panels P1 or displaying multiple second panels P2 in the setting area 12, the panel display controller 30 shrinks both the first panel P1 and the second panel P2 in the left-right direction (arrangement direction D) for display. When shrinking first panels P1 or second panels P2, the display within the panels may be shrunk or changed to a simplified display. In the case of displaying a plurality of first panels P1 and a plurality of second panels P2 simultaneously, the width in the left-right direction of each of the first panels P1 and the second panels P2 displayed in the setting area 12 may be the same or different.

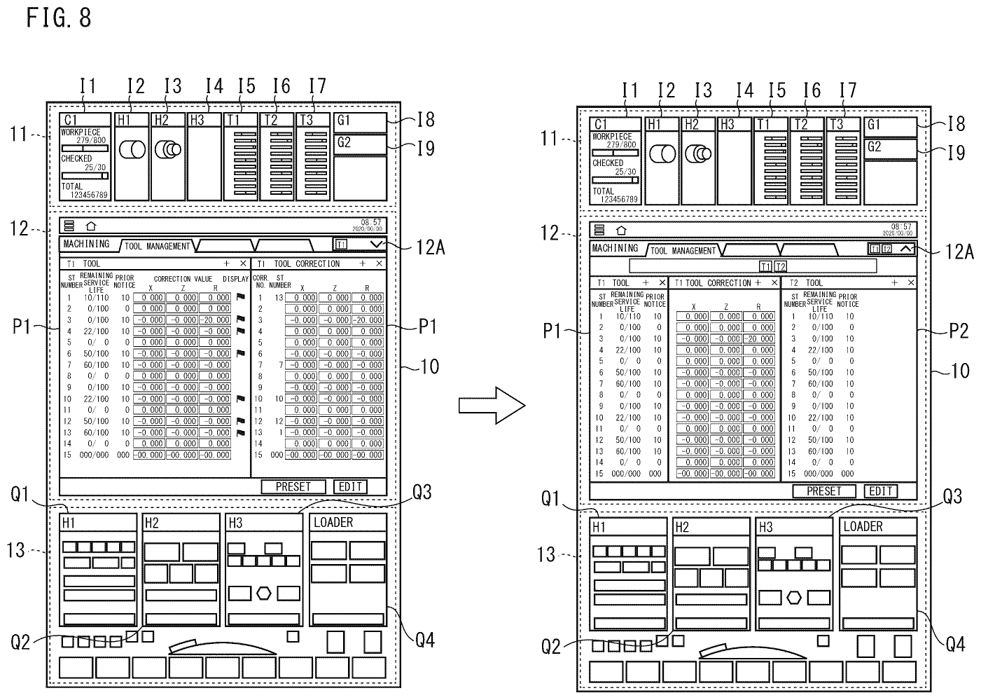

FIG. 8 is a diagram showing an example in which a second panel P2 is displayed in addition to a plurality of first panels P1. As shown in FIG. 8, when a touch input is performed on the button 12A in the state where a plurality of (two) first panels P1 are displayed in the setting area 12, the panel display controller 30 displays the second panel P2 on the another side (right side in the present example embodiment) with respect to the two first panels P1 in the arrangement direction D in the setting area 12. That is to say, in the state where a plurality of first panels P1 are displayed in the setting area 12, in order to display a new second panel P2, the panel display controller 30 maintains the display of the plurality of first panels P1 and displays the second panel P2 on the another side with respect to any of the multiple first panels P1 in the arrangement direction D. At this time, the two first panels P1 having been displayed in the entire setting area 12 are now shrunk in the left-right direction as the second panel P2 is displayed.

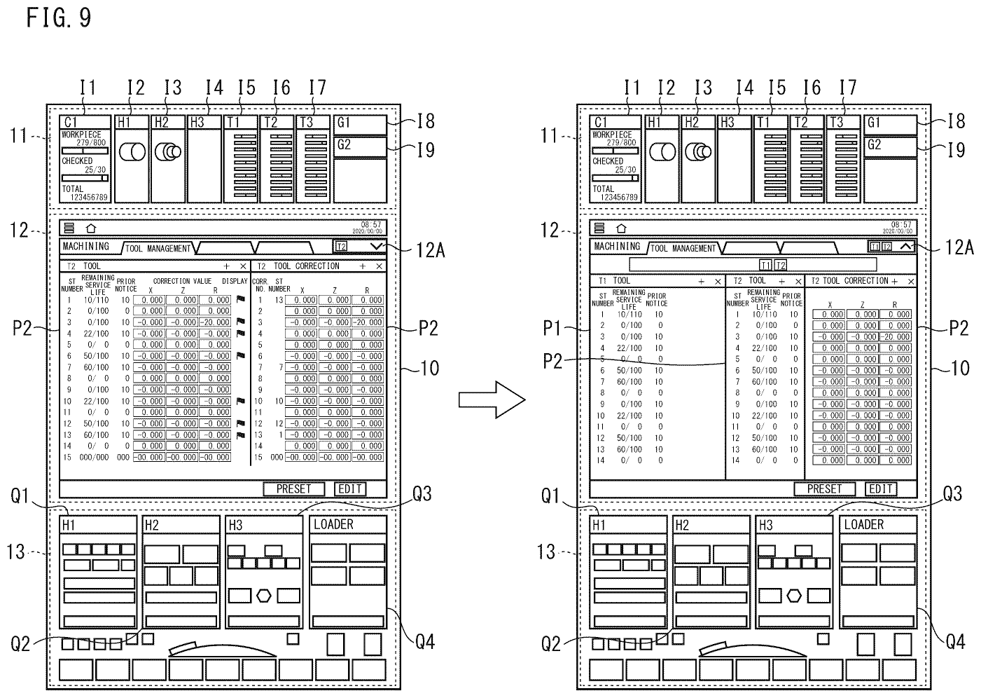

FIG. 9 is a diagram showing an example in which a first panel P1 is displayed in addition to a plurality of second panels P2. As shown in FIG. 9, when a touch input is performed on the button 12A in the state where a plurality of (two) second panels P2 are displayed in the setting area 12, the panel display controller 30 displays the first panel P1 on the one side (left side in the present example embodiment) with respect to the two second panels P2 in the arrangement direction D in the setting area 12. That is to say, in the state where a plurality of second panels P2 are displayed in the setting area 12, in order to display a new first panel P1, the panel display controller 30 maintains the display of the plurality of second panels P2 and displays the first panel P1 on the one side with respect to any of the multiple second panels P2 in the arrangement direction D. At this time, the two second panels P2 having been displayed in the entire setting area 12 are now shrunk in the left-right direction as the first panel P1 is displayed.

Thus, when displaying a first panel P1 and second panels P2 simultaneously in the setting area 12, one or more of the second panels P2 are all displayed on the another side with respect to the first panel P1 in the arrangement direction D. Also, when a plurality of first panels P1 are displayed, one or more of the second panels P2 are all displayed on the another side with respect to the first panel P1 in the arrangement direction D. When displaying first panels P1 and a second panel P2 simultaneously in the setting area 12, one or more of the first panels P1 are all displayed on the one side with respect to the second panel P2 in the arrangement direction D. Also, when a plurality of second panels P2 are displayed, one or more of the first panels P1 are all displayed on the one side with respect to the second panels P2 in the arrangement direction D. Thus, the arrangement order of the panels displayed in the setting area 12 matches the actual arrangement of the first element E1 and the second element E2 in the arrangement direction D in the industrial machine S. Therefore, the operator can readily recognize the first panel P1 or the second panel P2 of the setting target, and this helps reduce operational errors such as input errors.

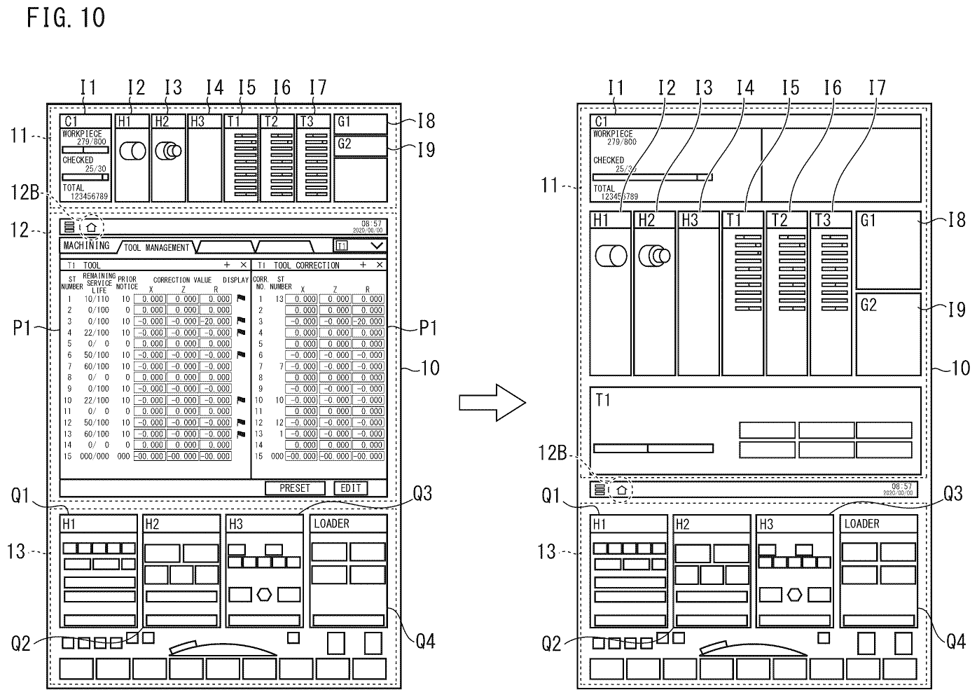

FIG. 10 is a diagram showing an example of a state in which the setting area 12 is shrunk. As a use mode of the operating apparatus 100, when settings or operations are not being performed on the first element E1 or the second element E2 of the industrial machine S, the operator can also use the operating apparatus 100 as a monitor to view information in the information area 11. In such a case, as shown in FIG. 10, for example, as the operator performs a touch input on a home button 12B displayed in the setting area 12, the panel display controller 30 can vertically shrink the setting area 12, allowing the display of the information area 11 to be enlarged correspondingly. As the information area 11 becomes enlarged, the panels I1 to I9 also become enlarged for display. When the panels I1 to I9 are enlarged for display, the display within the panel may be enlarged, or information that is hidden prior to the enlargement may be added for display.

Thus, enlarging the information area 11 (panels I1 to I9) enables the operator to easily check the information in the information area 11. To restore the shrunk setting area 12 to its original state, the home button 12B is pressed again. It should be noted that the setting area 12 is shrunk and the information area 11 is enlarged in the example above, however, the invention is not limited to this example. For example, the operation area 13 may be shrunk vertically to enlarge the information area 11, or both the setting area 12 and the operation area 13 may be shrunk vertically to enlarge the information area 11.

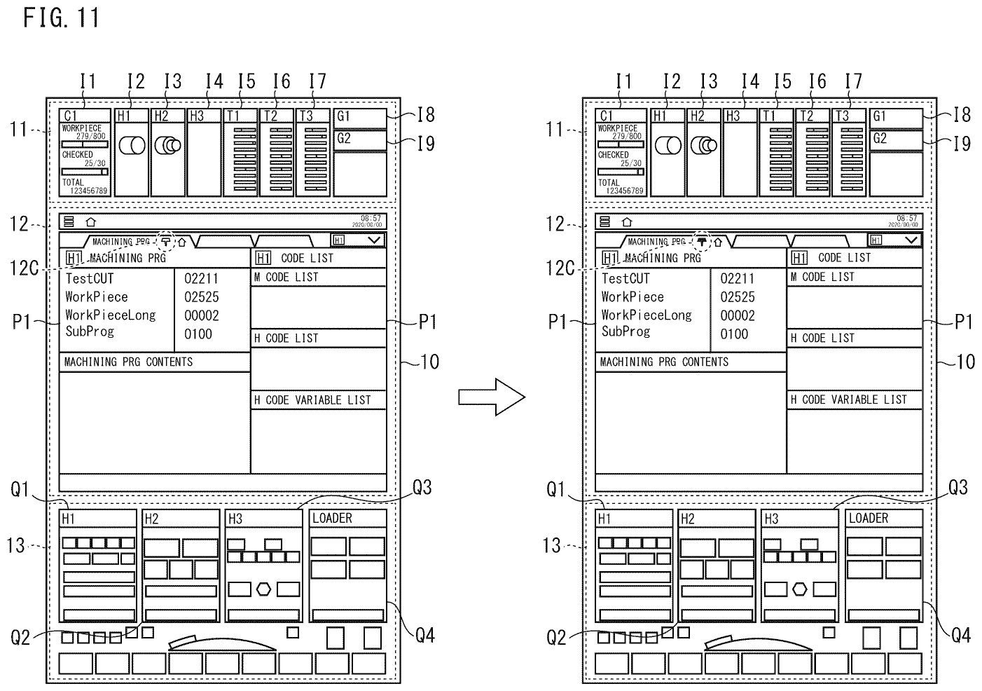

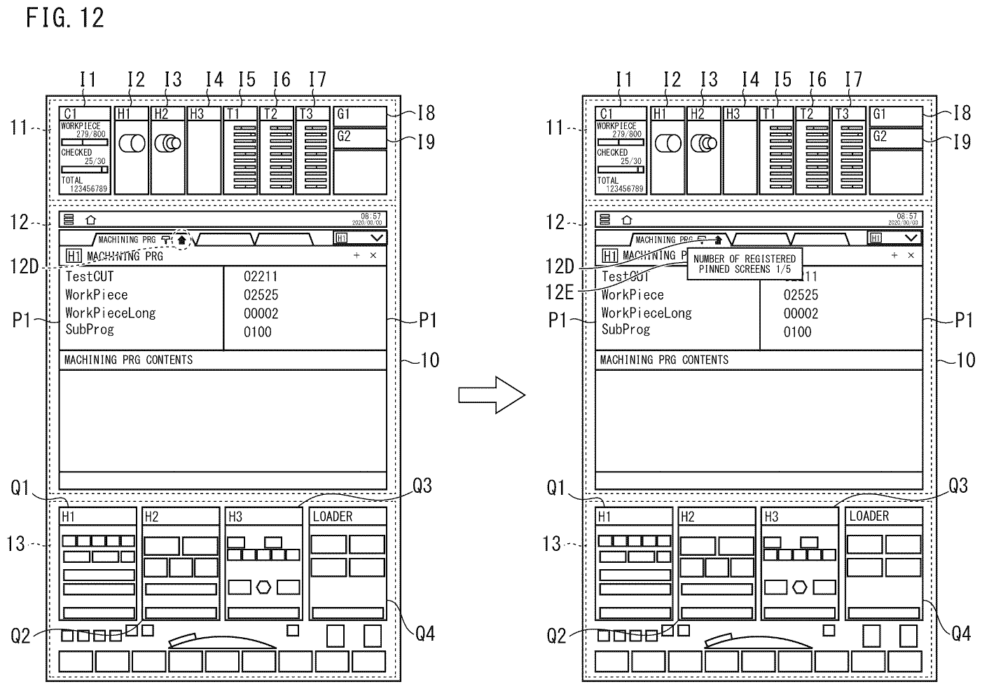

FIG. 11 and FIG. 12 are diagrams showing another use mode of the operating apparatus 100. FIG. 11 is a diagram showing an example of an operation for pinning a panel. FIG. 12 is a diagram showing an example of an operation for recalling the pinned panel. As shown in FIG. 11, when the operator performs a touch input on a pin button 12C displayed on the first panel P1, the panel display controller 30 can store the display mode of the two first panels P1 displayed in the setting area 12 into a memory storage not shown in the drawings. FIG. 11 shows the pinned state of a mode in which two first panels P1 are displayed in the setting area 12, however, a mode in which one or three or more first panels P1 are displayed is also pinned in a similar manner. Furthermore, a mode in which second panels P2 are displayed in the setting area 12, and a mode in which a first panels P1 and a second panel P2 are simultaneously displayed are also pinned in a similar manner. The pinned content can be stored in the memory storage, for example, with a name assigned thereto.

The operator can later easily display the first panel P1 or the second panel P2 in the setting area 12 by recalling the pinned display content. As shown in FIG. 12, the operator performs a touch input on a pinned contents recall button 12D displayed in the first panel P1 (or second panel P2). This touch input causes the panel display controller 30 to display a list 12E related to the pinned contents in the first panel P1 (or second panel P2). As the operator selects one of the items on the list 12E by touch input, the panel display controller 30 displays the selected pinned mode in the setting area 12. Thus, the operator can easily display a frequently used mode in the setting area 12 by pinning the mode in advance.

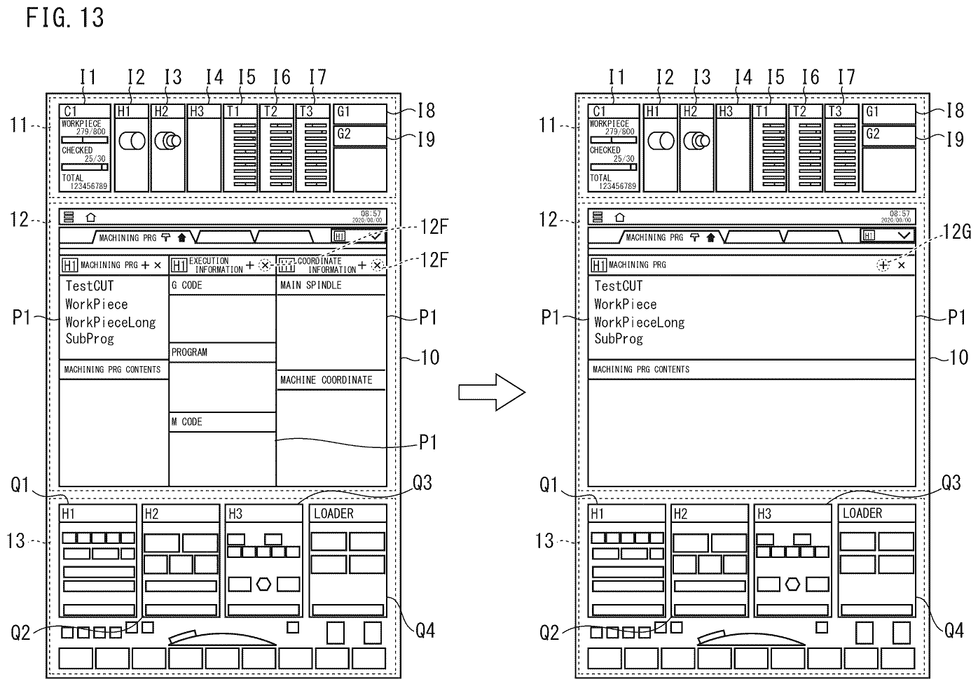

FIG. 13 is a diagram showing an example of an operation for closing panels. As shown in FIG. 13, a delete button 12F for closing the panel is displayed on the first panel P1. In FIG. 13, three first panels P1 are displayed in the setting area 12, and the delete button 12F is displayed on each of the first panels P1. When the operator performs a touch input on the delete button 12F, the panel display controller 30 hides the corresponding first panel P1 in the setting area 12. As shown in the left figure of FIG. 13, when a touch input is performed on each delete button 12F to hide the two corresponding first panels P1, the panel display controller 30 enlarges and displays the one remaining first panel P1 in the setting area 12, as shown in the right figure of FIG. 13.

This operation is also similar in the case where a second panel P2 is displayed in the setting area 12, or the case where both a first panel P1 and a second panel P2 are displayed simultaneously in the setting area 12. A touch input performed on the delete button 12F can hide the corresponding first panel P1 or the second panel P2 in the setting area 12. At this time, the first panel P1 or the second panel P2 remaining in the setting area 12 is also enlarged in the setting area 12 for display in a similar manner.

As shown in FIG. 13, an add button 12G is displayed on each of the first panels P1. In the right figure of FIG. 13, one first panel P1 is displayed in the setting area 12. As the operator performs a touch input on the add button 12G for panel addition, the panel display controller 30 adds one first panel P1 to display two first panels P1 in the setting area 12. When adding a first panel P1, the panel display controller 30, for example, shrinks the first panel P1 that has already been displayed and displays it to the right of the first panel P1 to be added (see FIG. 4). The panel display controller 30 adjusts the sizes (widths in left-right direction) of the two first panels P1 so that the previously displayed first panel P1 and the additional first panel P1 use the entire setting area 12.

This operation is also similar in the case where a second panel P2 is displayed in the setting area 12, or the case where both a first panel P1 and a second panel P2 are displayed simultaneously in the setting area 12. In such a case, when a touch input is performed on the add button 12G of the first panel P1, a first panel P1 is added, and when a touch input is performed on the add button 12G of the second panel P2, a second panel P2 is added. The first panel P1 or the second panel P2 to be added is determined in advance by the settings made by the operator or by the initial settings, depending on the first panel P1 or the second panel P2 for which a touch input is to be performed on the add button 12G. Thus, by performing a touch input on the delete button 12F or the add button 12G, the operator can easily hide or add a first panel P1 or a second panel P2 displayed in the setting area 12.

Here, in the state where a first panel P1 and a second panel P2 are displayed in the setting area 12, if a touch input is performed on the add button 12G of the second panel P2, an additional second panel P2 is displayed on the another side with respect to the first panel P1 in the arrangement direction D. In the case where a plurality of first panels P1 are displayed, an additional second panel P2 is displayed on the another side with respect to any of the first panels P1 in the arrangement direction D. Moreover, in the state where a first panel P1 and a second panel P2 are displayed in the setting area 12, if a touch input is performed on the add button 12G of the first panel P1, an additional first panel P1 is displayed on the one side with respect to the second panel P2 in the arrangement direction D. In the case where a plurality of second panels P2 are displayed, an additional first panel P1 is displayed on the one side with respect to any of the second panels P2 in the arrangement direction D.

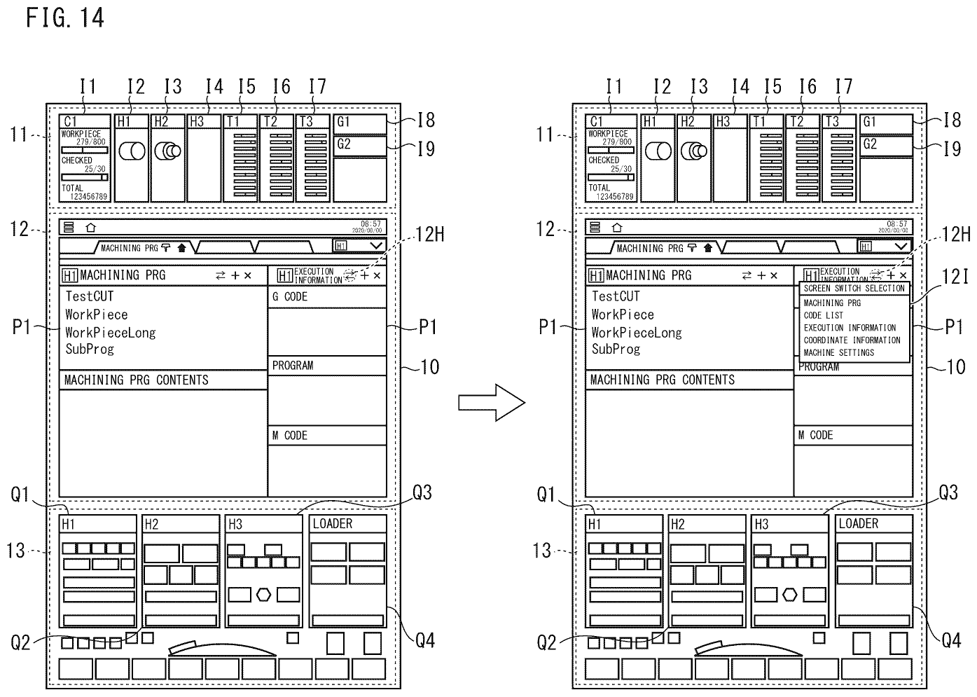

FIG. 14 is a diagram showing an example of a panel change operation. As shown in FIG. 14, two first panels P1 are displayed in the setting area 12, and a change button 12H for panel changing is displayed on each of the first panels P1. When the operator performs a touch input on the change button 12H, the panel display controller 30 displays an item list 12I of panel items to be displayed after a panel change, as shown in the right figure of FIG. 14. When the operator selects a desired item from the item list 12h by a touch input, the panel display controller 30 changes the display content of the first panel P1 to the content of the selected item and displays it. The items displayed in the item list 12I are set in advance by the operator or are determined by the initial settings.

This operation is also similar in the case where a second panel P2 is displayed in the setting area 12, or the case where both a first panel P1 and a second panel P2 are displayed simultaneously in the setting area 12. In such a case, for each first panel P1 and second panel P2, the panel display controller 30 may display an item list 121 corresponding to each panel or may display the same item list 121. Thus, the panel content can be changed by performing a touch input on the change button 12H and selecting a desired item from the item list 12h, and therefore the operator can easily change the display content of a first panel P1 or a second panel P2.

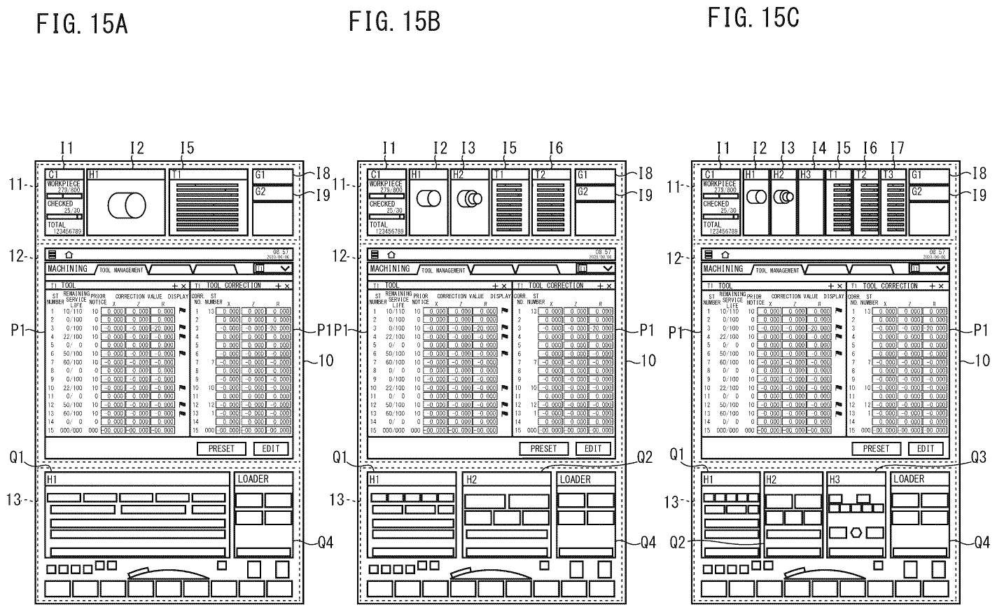

FIGS. 15A to 15C are diagrams showing the relationship between the information area 11 and the operation area 13. FIG. 15A shows a state in which one element is displayed in the information area 11. FIG. 15B shows a state in which two elements are displayed in the information area 11. FIG. 15C shows a state in which three elements are displayed in the information area 11. The panel display controller 30 can display on the display 10 each element to be displayed in the information area 11 and a panel Q to be displayed in the operation area 13 in correspondence with each other. Each element to be displayed in the information area 11 may be set, for example, by the operator's input or may be set by receiving information related to the industrial machine S from a host controller. When the industrial machine S and the operating apparatus 100 are shipped from the factory as a set, each element of the industrial machine S may be initially set in the information area 11.

As shown in FIG. 15A, when panels 12, 15 related to one main spindle H1 and one turret T1 (that is, first element E1) are displayed in the information area 11, the panel display controller 30 displays one panel Q1 for operating the main spindle H1 in the operation area 13. As shown in FIG. 15B, when panels I2, I3 related to two main spindles H1, H2 and two turrets T1, T2 (that is, first element E1 and second element E2) are displayed in the information area 11, the panel display controller 30 displays two panels Q1, Q2 for operating the main spindles H1, H2 in the operation area 13. As shown in FIG. 15C, when panels I2, I3, I4 related to three main spindles H1, H2, H3 and three turrets T1, T2, T3 (that is, when an element is further added to the first element E1 and the second element E2) are displayed in the information area 11, the panel display controller 30 displays three panels Q1, Q2, Q3 for operating the main spindles H1, H2, H3 in the operation area 13. Thus, each element displayed in the information area 11 corresponds to the panel Q displayed in the operation area 13, so that the operator can readily grasp the element that can be operated.

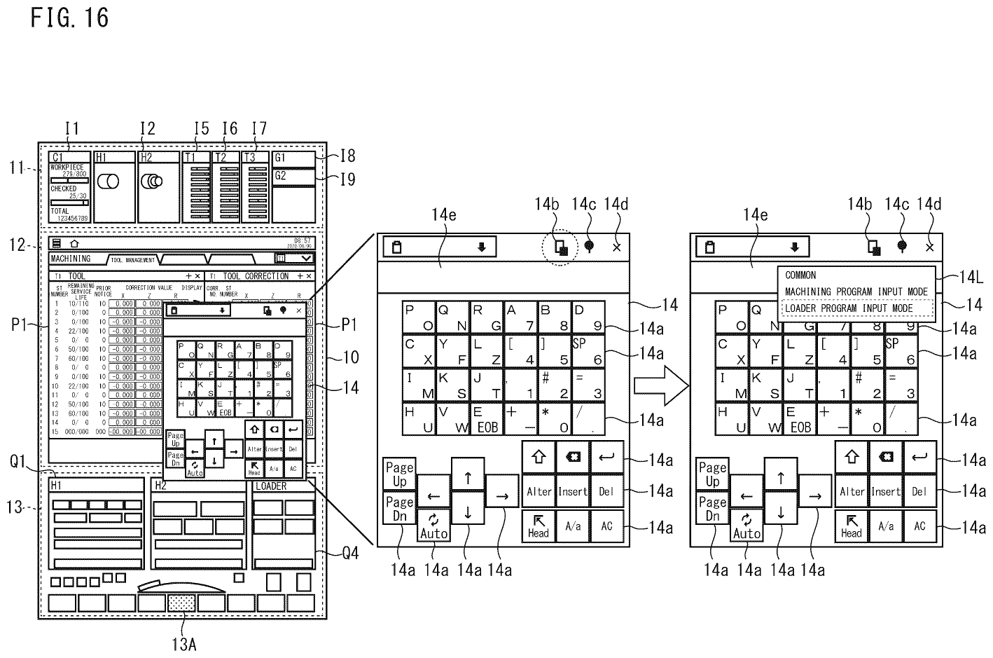

FIG. 16 is a diagram showing an example of a state in which a numeric keypad panel 14 for settings is displayed on the display 10. As shown in FIG. 16, when the operator performs a touch input on an edit mode button 13A displayed in the operation area 13, the panel display controller 30 displays a numeric keypad panel 14 on the display 10 for editing the contents of the first panel P1 or the second panel P2 displayed in the setting area 12. The numeric keypad panel 14 is displayed so as to hover over the setting area 12 and the operation area 13 on the display 10. At this time, the panel display controller 30 displays the numeric keypad panel 14 in the foreground of the first panel P1 or the second panel P2 in the setting area 12 and the panel Q in the operation area 13. The position where the numeric keypad panel 14 is displayed within the display 10 is arbitrary. Also, instead of displaying the numeric keypad panel 14 on a portion of the display 10, the numeric keypad panel 14 may be displayed on the entire screen of the display 10.

The numeric keypad panel 14 includes a plurality of key buttons 14a usable to input letters, numbers, predetermined commands, and so forth, an input mode selection button 14b usable to set an input mode, a pin button 14c usable to keep the numeric keypad panel 14 in the state of being displayed, a close button 14d for closing the numeric keypad panel 14, and an input content display 14e to display input contents. As shown in FIG. 16, when the operator performs a touch input on the input mode selection button 14b, the panel display controller 30 displays a list 14L of input modes. In the list 14L, for example, an input mode for editing a machining program, an input mode usable to edit a loader program, a common input mode usable to edit other modes, and so forth are listed for display.

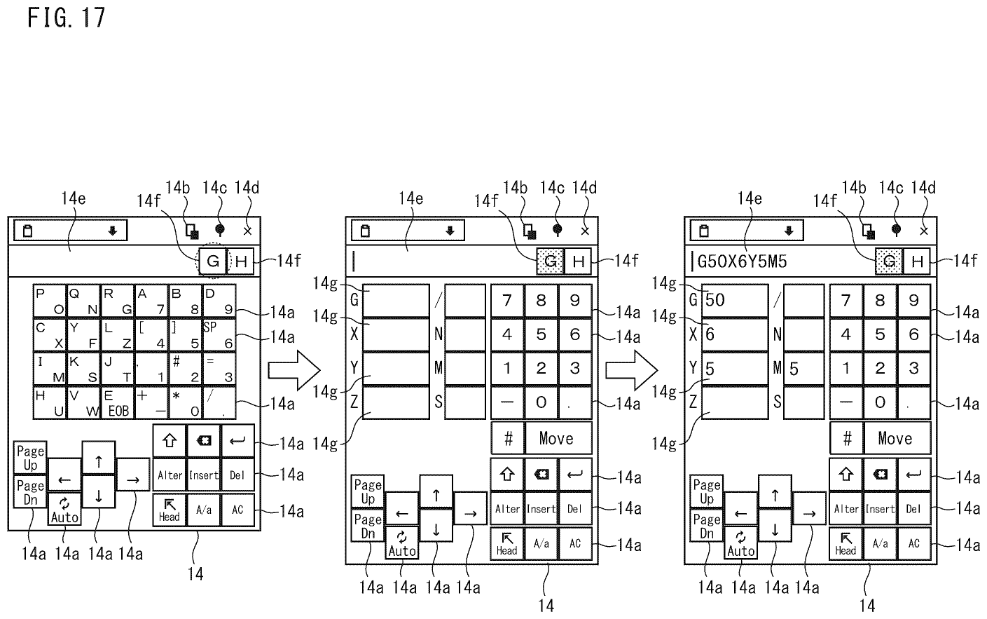

FIG. 17 is a diagram showing an example of the numeric keypad panel 14. FIG. 17 shows the numeric keypad panel 14 in the state where the operator selects the input mode for editing a loader program by touch input from the list 14L shown in FIG. 16. As shown in FIG. 17, the numeric keypad panel 14 displays selection buttons 14f for selecting a code type for editing a loader program. Examples of such a code include a G code, which is a general input code, and an H code, which is uniquely set in the industrial machine S. When the operator selects a code using the selection button 14f by touch input, the panel display controller 30 changes and displays the numeric keypad panel 14 according to the selected code. By highlighting or dimming the selected code, the operator can easily check which code has been selected. FIG. 17 shows a case where the G code is selected.

When the G code is selected, the numeric keypad panel 14 changes to a screen for editing the G code. As shown in FIG. 17, the numeric keypad panel 14 has code displays 14g arranged in line to display input values for G, X, Y, Z, /, N, M, S that make up the G code. In sequence according to the arrangement of the code displays 14g, the operator performs a touch input on one of the code displays 14g and then touches the key buttons 14a to input a numerical value. The settings of the G code is completed by repeating this operation.

For example, the operator performs touch inputs alternately on one of the code displays 14g and the key buttons 14a to input the values for “G”, “50”, “X”, “6”, “Y”, “5”, “M”, “5” according to the arrangement order of the code displays 14g. When there is a code display 14g that is not to receive a numerical value input, the button is skipped and the next code display 14g is touched for input. Upon completing such an input operation, the G code “G50X6Y5M5” is set on the numeric keypad panel 14. At this time, the panel display controller 30 displays 50 in the code display 14g that indicates the value of G, 6 in the code display 14g that indicates the value of X, 5 in the code display 14g that indicates the value of Y, and 5 in the code display 14g that indicates the value of M.

Thus, the operator completes the setting of the G code by selecting the G code and then sequentially performing touch inputs on the code displays 14g and touch-inputting numerical values using the key buttons 14a, in the order in the code displays 14g. Thus, the operator only needs to input required numerical values sequentially for “G” arranged in the code displays 14g. Consequently, setting the G code can be performed quickly and accurately, alleviating the operator's workload.

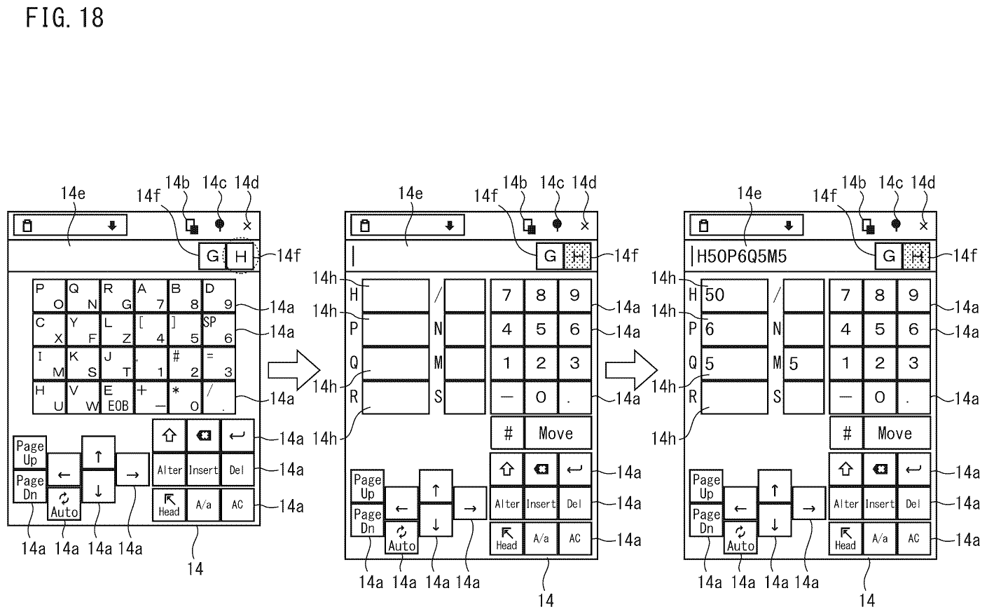

FIG. 18 is a diagram showing another example of the numeric keypad panel 14. FIG. 18 shows the numeric keypad panel 14 in the case where the H code is selected. When the H code is selected using the selection button 14f, the numeric keypad panel 14 changes to a screen for editing the H code. As shown in FIG. 18, the numeric keypad panel 14 has code displays 14h arranged in line to display input values for H, P, Q, R, /, N, M, S that make up the H code. As in the manner described above, the operator performs touch inputs alternately on one of the code displays 14h and the key buttons 14a to input the values for “H”, “50”, “P”, “6”, “Q”, “5”, “M”, “5” according to the order of the code displays 14h. When there is a code display 14h that is not to receive a numerical value input, the button is skipped and the next code display 14h is touched for input. Upon completing such an input operation, the H code “H50P6Q5M5” is set on the numeric keypad panel 14. At this time, the panel display controller 30 displays 50 in the code display 14h that indicates the value of H, 6 in the code display 14h that indicates the value of P, 5 in the code display 14h that indicates the value of Q, and 5 in the code display 14h that indicates the value of M.

Thus, as with the G code, also when the H code is selected, the operator completes the setting of the H code by sequentially performing touch inputs on the code displays 14h and touch-inputting numerical values using the key buttons 14a, in the order of the code displays 14h. Thus, the operator only needs to input required numerical values sequentially for “H” arranged in the code displays 14h. Consequently, setting the H code can be performed quickly and accurately, alleviating the operator's workload.

FIG. 19 is a diagram showing another example of a lathe MB being the industrial machine S. FIG. 19 shows a modified example of the industrial machine S. It should be noted that FIG. 19 only illustrates a main part (a portion) of the lathe MB. The lathe MB is an opposed twin spindle lathe. The lathe MB has two main spindles H1A, H2A arranged in a manner of opposing each other, and three turrets T1A, T2A, T3A. The main spindles H1A, H2A are each supported by a bearing or the like not shown in the drawings so as to be able to rotate around a single axis line parallel to the Z1 direction. Chucks 321, 322 are provided at a +X1 side end of the main spindles H1A and a −X1 side end of the main spindle H2A, respectively. The chucks 321, 322 are opened and closed by a chuck driver not shown in the drawings to grip or release the workpiece W.

The turrets T1A, T2A, T3A are spaced away from the axial direction of the main spindles H1A, H2A. The turrets T1A, T3A are arranged above (on the +Y1 side) of the main spindles H1A, H2A. The turret T2A is arranged below (on the −Y1 side) of the main spindles H1A, H2A. The turret T1A is arranged in correspondence with a workpiece W held by the chuck 321 of the main spindle H1A. The turrets T2A, T3A are arranged in correspondence with a workpiece W held by the chuck 322 of the main spindle H2A. Each of the turrets T1A, T2A, 13A can be rotated around an axis parallel to the X1 direction by a rotation driver not shown in the drawings. A plurality of holders for holding tools TL are provided on the circumferential surfaces of the turrets T1A, T2A, T3A, and tools T are held in all or some of these holders. Thus, the tool TL used for machining a workpiece W is selected by rotating the turrets T1A, T2A, T3A. The turrets T1A, T2A, T3A can be moved in the X1 direction and the Y1 direction by drivers not shown in the drawings.

In the lathe MB, the main spindle H1A and the turret T1A constitute a first element E1C, and the main spindle H2A and the turret T2A constitute a second element E2C. The main spindle H2A and the turret T3A constitute a third element E3C. The first element E1C, the second element E2C, and the third element E3C are arranged in line along the predetermined arrangement direction D. The first element E1C is arranged on the one side (left side) in the arrangement direction D, the second element E2C is arranged on the another side (left side) with respect to the first element E1C in the arrangement direction D, and the third element E3C is arranged on the another side (left side) with respect to the second element E2C in the arrangement direction D.

In the operating apparatus 100 described above, the reference signs H1, H2 displayed on the display 10 correspond to the main spindles H1A, H2A in FIG. 19, and the reference signs T1, T2, T3 correspond to the turrets T1A, T2A, T3A in FIG. 19. The operating apparatus 100 displays a first panel P1 and a second panel P2 in the setting area 12 of the display 10 in the same order as that in which the main spindle H1A and the turret T1A, and the main spindle H2A and the turret T2A are arranged in the arrangement direction D, and therefore the operator can readily grasp the setting target, and operational errors such as input errors can be reduced.

In the case where the operator performs a touch input on the panel 17 displayed in the information area 11 of the display 10 as shown in FIG. 1 and so forth, the panel display controller 30 displays a third panel in the setting area 12. The third panel displays information required for various settings for the turret T3A (or the tool TL held by the turret T3A). For example, in the setting area 12, this third panel is displayed on the another side (left side) with respect to both the first panel P1 and the second panel P2 in the predetermined arrangement direction D. In other words, the third panel is arranged at least on the another side with respect to the first panel P1 in the predetermined arrangement direction D, and therefore, the third panel can be said to correspond to the second panel P2. Even in the case of displaying the third panel in the setting area 12, the first panel P1, the second panel P2, and the third panel are displayed in the setting area 12 of the display 10 in the same order as that in which the turrets T1A, T2A, T3A are arranged in the arrangement direction D, and therefore the operator can readily grasp the setting target, and operational errors such as input errors can be reduced.

FIG. 20 is a diagram showing an example of an automated warehouse R being the industrial machine S. FIG. 20 shows a modified example of the industrial machine S. The automated warehouse R is a facility (apparatus) that automatically transfers articles M between multiple storages 400 and transfer parts for transferring items to and from external entities. As shown in FIG. 20, the automated warehouse R includes an outer panel 401 that forms an internal space K, a plurality of racks 402 provided in multiple stages in the internal space K, a plurality of walls 403 standing in parallel in the internal space K, a rail 404 provided on the bottom surface of the internal space K, and two transport carriers, namely, a first transport carrier 410A and a second transport carrier 410B. The automated warehouse R also includes a controller CB configured or programmed to control the first transport carrier 410A and the second transport carrier 410B. The automated warehouse R has a plurality of storages 400 partitioned by a plurality of racks 402 and a plurality of walls 403. The plurality of storages 400 are aligned vertically and horizontally (in Z2 direction and X2 direction). Each storage 400 is set to a size capable of storing articles M therein.

The rail 404 is provided on the bottom surface of the internal space K and extends in the X2 direction. The first transport carrier 410A and the second transport carrier 410B travel along the rail 404 in the X2 direction. The first transport carrier 410A and the second transport carrier 410B use, for example, stacker cranes and have the same configuration. The first transport carrier 410A is arranged on the one side (left side) in the arrangement direction D, and the second transport carrier 410B is arranged on the another side (right side) in the arrangement direction D. The first transport carrier 410A and the second transport carrier 410B include a traveling carrier 411 that travels on the rail 404, a mast 412 that stands up from the traveling carrier 411, an elevation platform 413 that ascends and descends while being guided by the mast 412, and a transferer 414 mounted on the elevation platform 413.

The first transport carrier 410A,the second transport carrier 410B each position the transferer 414 at one of the multiple storages 400, depending on the traveling position of the traveling carrier 411 in the X2 direction and the elevation position of the elevation platform 413 in the Z2 direction. Next, by driving the transferer 414 in this state, an article M is transferred between the storage 400 and the transferer 414. At least one of the first transport carrier 410A and the second transport carrier 410B transfers an article M to and from a transfer part not shown in the drawings for transferring articles M to and from the external entities.

In the automated warehouse R, the first transport carrier 410A constitutes a first element E1D, and the second transport carrier 410B constitutes a second element E2D. The first element E1D and the second element E2D are arranged in line along the predetermined arrangement direction D. The first element E1D is arranged on the one side (left side) in the arrangement direction D, and the second element E2D is arranged on the another side (right side) in the arrangement direction D. When performing setting for the first element E1D and the second element E2D of the automated warehouse R using the operating apparatus 100 described above, the setting area 12 of the display 10 displays a first panel P1 for setting the first element E1D and a second panel P2 for setting the second element E2D. At this time, the first panel P1 and the second panel P2 are displayed in the setting area 12 in the same order as that in which the first transport carrier 410A and the second transport carrier 410B are arranged in the arrangement direction D. Therefore, the operator can readily grasp the setting target, and operational errors such as input errors can be reduced.

The example embodiments of the present invention has been described above. However, the technical scope of the present invention is not limited to the description of the above example embodiments. Various modifications or improvements can be added to the above example embodiments. The technical scope of the present invention also encompasses one or more of such modifications or improvements. One or more of the elements, features, characteristics, etc., described in the above example embodiments may be omitted in some cases. One or more of the elements, features, characteristics, etc., described in the above example embodiments may be combined where appropriate. The order of executing processes shown in the present example embodiments can be realized in an arbitrary order unless an output of the previous processing is used in the following processing. While operations in the above example embodiments have been described with expressions such as “first”, “next”, and “subsequently” for the sake of convenience, the operations need not always be implemented in that order.

In the above example embodiments, an example of arranging multiple first panels P1 or multiple second panels P2 in the horizontal direction (left-right direction) in the setting area 12 has been explained, however, example embodiments of the present invention are not limited to this example. Multiple first panels P1 or multiple second panels P2 may also be arranged in the setting area 12 in the vertical direction (up-down direction). Even in such a case, when simultaneously displaying first panels P1 and second panels P2 in the setting area 12, all of the multiple second panels P2 are arranged on the another side with respect to the first panels P1 in the predetermined arrangement direction D.

It should be noted that the technical scope of the present invention is not limited to the above example embodiments. One or more of the elements, features, characteristics, etc., described in the above example embodiments may be omitted in some cases. One or more of the elements, features, characteristics, etc., described in the above example embodiments may be combined where appropriate.

The contents of Japanese Patent Application No. 2022-008935 and all documents cited in the detailed description of the present invention are incorporated herein by reference to the extent permitted by law.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-16. (canceled)

17. An operating apparatus to operate an industrial machine that includes a first element on one side in a predetermined arrangement direction and a second element on another side in the predetermined arrangement direction, the operating apparatus comprising:
a touch panel display to display an image and usable to perform input on the image displayed; and
a panel display controller configured or programmed to cause the touch panel display to display a first panel usable to perform settings regarding the first element, and a second panel usable to perform settings regarding the second element on the another side with respect to the first panel; wherein
when an input to display a new one of the first panel is performed via the touch panel display, the panel display controller is configured or programmed to display the new one of the first panel on the one side with respect to the second panel having been displayed on the touch panel display; and
when an input to display a new one of the second panel is performed via the touch panel display, the panel display controller is configured or programmed to display the new one of the second panel on the another side with respect to the first panel having been displayed on the touch panel display.

18. The operating apparatus according to claim 17, wherein the panel display controller is configured or programmed to cause the touch panel display to display a plurality of the first panel and to display a plurality of the second panel on the another side with respect to any of the plurality of first panel.

19. The operating apparatus according to claim 17, wherein
when an input to display a new one of the first panel is performed via the touch panel display, the panel display controller is configured or programmed to display the new one of the first panel on the one side with respect to any one of a plurality of the second panel having been displayed on the touch panel display; and
when an input to display a new one of the second panel is performed via the touch panel display, the panel display controller is configured or programmed to display the new one of the second panel on the another side with respect to any one of a plurality of the first panel having been displayed on the touch panel display.

20. The operating apparatus according to claim 17, wherein
when an input to display a new one of the first panel is performed via the touch panel display, the panel display controller is configured or programmed to first display the new one of the first panel on the another side with respect to the second panel having been displayed on the touch panel display, and then, swap positions of the new one of the first panel and the second panel to display the new one of the first panel on the one side with respect to the second panel; and
when an input to display a new one of the second panel is performed via the touch panel display, the panel display controller is configured or programmed to display the new one of the second panel on the another side with respect to the first panel from a time point at which displaying starts.

21. The operating apparatus according to claim 20, wherein
when an input to display a new one of the first panel is performed via the touch panel display, the panel display controller is configured or programmed to first display the new one of the first panel on the another side with respect to any one of a plurality of the second panel having been displayed on the touch panel display, and then, move the new one of the first panel to the one side with respect to any one of the plurality of the second panel while moving the plurality of the second panel to the another side with respect to the new one of the first panel, to display the new one of the first panel on the one side with respect to any one of the plurality of the second panel; and
when an input to display a new one of the second panel is performed via the touch panel display, the panel display controller is configured or programmed to display the new one of the second panel on the another side with respect to any one of a plurality of the first panel from a time point at which displaying starts.

22. The operating apparatus according to claim 17, wherein when an input to display a new panel is performed via the touch panel display, the panel display controller is configured or programmed to first display the new panel on the another side with respect to the second panel having been displayed on the touch panel display, then further accept, via the touch panel display, designation of whether the new panel is the first panel or the second panel, and, if the new panel is designated as the first panel, display the new panel on the one side with respect to the second panel by swapping positions of the new panel and the second panel.

23. The operating apparatus according to claim 22, wherein when an input to display a new panel is performed via the touch panel display, the panel display controller is configured or programmed to first display the new panel on the another side with respect to any one of a plurality of the second panel having been displayed on the touch panel display, then further accept, via the touch panel display, designation of whether the new panel is the first panel or the second panel, and, if the new panel is designated as the first panel, move the new panel to the one side with respect to any one of the plurality of the second panel while moving the plurality of the second panel to the another side with respect to the new panel, to display the new panel on the one side with respect to any one of the plurality of the second panel.

24. The operating apparatus according to claim 17, wherein the panel display controller is configured or programmed to display one or both of the first panel and the second panel over all or substantially all of a setting area preliminarily prescribed on the touch panel display.

25. The operating apparatus according to claim 24, wherein, when displaying a new one of the first panel or a new one of the second panel in the setting area, the panel display controller is configured or programmed to shrink one or both of the first panel and the second panel that have been displayed first.

26. The operating apparatus according to claim 17, wherein the touch panel is attachable to the industrial machine in a removable manner.

27. The operating apparatus according to claim 17, wherein
the industrial machine is a lathe; and
the first element and the second element are both machining units included in the lathe.

28. The operating apparatus according to claim 17, wherein
the industrial machine is a loader device; and
the first element and the second element are both transporters included in the loader device.

29. The operating apparatus according to claim 17, wherein
the industrial machine is an automated warehouse; and
the first element and the second element are both transport carriers included in the automated warehouse.

30. A display method for an operating apparatus to operate an industrial machine that includes a first element on one side in a predetermined arrangement direction and a second element on another side in the predetermined arrangement direction, the operating apparatus including a touch panel display to display an image and perform input on the image displayed, the display method comprising:
causing the touch panel display to
display a first panel to perform settings regarding the first element, and a second panel to perform settings regarding the second element on the another side with respect to the first panel;
when an input to display a new one of the first panel is performed via the touch panel display, displaying the new one of the first panel on the one side with respect to the second panel having been displayed on the touch panel display; and
when an input to display a new one of the second panel is performed via the touch panel display, displaying the new one of the second panel on the another side with respect to the first panel having been displayed on the touch panel display.
